(19) United States
(12) Patent Application Publication
(10) Pub. No.: US 2023/0281745 A1
(43) Pub. Date: Sep. 7, 2023

(54) RULE WATCH SYSTEM

(71) Applicant: OSINTECH INC., Hyogo (JP)

(72) Inventors: Masato ODA, Hyogo (JP); Tomoyuki FUSE, Tokyo (JP)

(73) Assignee: OSINTECH INC., Hyogo (JP)

(21) Appl. No.: 18/016,739

(22) PCT Filed: Jan. 13, 2022
(86) PCT No.: PCT/JP2022/000979

§ 371 Date: Jan. 18, 2023

(30) Foreign Application Priority Data
Jan. 14, 2021 (JP) 2021-004565
Jan. 12, 2022 (JP) 2022-003416

(51) Int. Cl. G06Q 50/26; G06Q 50/00; G06F 16/951

(52) U.S. Cl. CPC G06Q 50/265; G06Q 50/01; G06F 16/951; H04L 67/02

(57) ABSTRACT

To provide a rule watch system and a rule watch method for reducing complexity of grasping information on rule formation. In a rule watch system, a crawler server includes collection means for collecting rule information composed of information on rule formation including regulations and standardization disclosed on the Internet on the basis of a collection condition, and translation means for translating the collected rule information into a prescribed language on the basis of a translation condition, a server includes simplification means for simplifying the rule information to concise information, and an SNS server includes contribution means for contributing the concise information to an SNS so as to make an SNS user monitor the rule formation.

### CROSS-REFERENCE TO RELATED APPLICATIONS

This is the U.S. National Phase under 35 U.S.C. 371 of International Application No. PCT/JP2022/000979, filed on Jan. 13, 2022, which in turn claims the benefit of Japanese Patent Application No. 2021-004565, filed on Jan. 14, 2021 and Japanese Patent Application No. 2022-003416, filed on Jan. 12, 2022, the disclosures of which are incorporated by reference herein.

### BACKGROUND OF THE INVENTION

### Field of the Invention

The present invention relates to a rule watch system or the like that monitors information relating to rule creation. The present invention further relates to a rule watch system or the like used in an SNS.

### Description of the Related Art

Patent Literature 1 discloses an information processing apparatus and the like that can suitably present information relating to pharmaceutical or medical regulations. An information processing method of the above collects regulation information relating to pharmaceutical or medical regulations published on the Internet with reference to acquisition rules indicating procedures of acquiring the regulation information, adds related information relating to the regulation information to the collected regulation information, and outputs the regulation information to which the related information has been added to a user.

Regarding the solution of global social issues, a recognition that those issues cannot be sufficiently dealt with by individual, inner-centered, and short-term thinking approaches that have been taken so far has spread, and an outside-in approach is starting to be required as a problem solution standing in a more long-term, diversified, and external perspective. However, there tends to be a lack of platforms where companies, researchers, and citizens deal with social issues by an outside-in approach crossing fields in a cross-cutting manner.

### CITATION LIST

### Patent Literature

Patent Literature 1: Japanese Patent Laid-Open No. 2020-190766

### SUMMARY OF THE INVENTION

Many people and companies are affected when rules including legal regulations and standardization are made, but there are few opportunities for the people and companies to be involved in rule creation. There are various languages and styles of information relating to rule creation in countries around the world, and it is cumbersome to monitor and check the information.

Thus, a problem to be solved by the present invention is to provide a rule watch system or the like that reduces cumbersomeness of grasping information relating to rule creation.

### Solution to Problem

(1) A rule watch method of the present invention is executed by one or a plurality of computers. The rule watch method includes: a step of collecting rule information including information relating to rule creation of an environmental issue, a human rights issue, a legal regulation, standardization, or the like published via the Internet on a basis of a collecting condition including a collecting source registered in advance; a step of forming concise information on a basis of predetermined information acquired from the rule information; and a step of making a first post on an SNS site for posting the concise information as the first post.

The “information relating to rule creation” is information relating to rule creation at home and abroad of environmental issues, human rights issues, standardization of technology, legal regulations, or the like. For example, the information is information on social issues and corresponding new technologies and services submitted from NGOs, companies, and the like. For example, the information is information on rules, provisions, standards, and arrangements for legal regulations and standardization. For example, the information is information gathered in a stage where public opinion is galvanized, a stage where a bill crafting institution is involved, a stage where a law is enacted by an assembly, a stage where an order is given from a public administration, and a stage where a decision is made by a court.

For example, an agreement on standardization defines things (products of productive activities) and those other than things (an organization, a responsible authority, a system, a method, and the like) in order to perform unification and simplification such that benefits or convenience can be fairly obtained among people involved. The information does not necessarily need to directly relate to rule creation. For example, the information may include information that eventually turns out to not relate to rule creation and only needs to be information having a possibility of relating to rule creation at the point of time of collection. The information is a concept including a value and information that can be converted to information relating to rule creation. For example, the information is the volume of greenhouse gas emission, an emission reduction goal, and the number of years for the goal.

The “rule information” includes information relating to rule creation and further includes information on text data and files, keywords (texts) for identifying document files from the inside of webpages, and metadata (for example, tag information of an HTML) associated with the document files, for example.

The “concise information” is information formed on the basis of predetermined information extracted and acquired from websites of rule information and websites of technical information and academic information in addition to the rule information. For example, the information is the date of publication, a title, and a country name/organization name in which the content is published. For example, the information may include at least one of a geographical name, a personal name, and a keyword extracted from the content. For example, at least one of an URL of a website, a summary, a part of the summary may be included.

(2) The rule watch method as above preferably further includes: a step of sorting the collected rule information into a predetermined category on a basis of a sorting condition; and a step of forming the concise information from the sorted rule information.

(3) The rule watch method as above preferably further includes, before the step of sorting, a step of translating, when the collected rule information includes a language different from a predetermined language, the language into the predetermined language on a basis of a translating condition so as to unify the language of the step of sorting and steps after the step of sorting.

(4) The rule watch method as above preferably further includes a step of measuring an attention degree of corresponding rule information on a basis of at least one of a number of comments, a number of reactions, a number of clicks of links for accessing the corresponding rule information, and a number by which collapsed display is unfolded by the user corresponding to the concise information that is posted.

(5) The rule watch method as above preferably further includes a step of determining a progress degree of the rule creation on a basis of organization information including an organization serving as the collecting source of the rule information.

(6) A rule watch system of the present invention includes: a crawler server including: collecting means for collecting rule information including information relating to rule creation of an environmental issue, a human rights issue, a legal regulation, standardization, or the like published via the Internet on a basis of a collecting condition including a collecting source registered in advance; and translating means for translating, when the collected rule information is different from a language to which translation is to be made, the collected rule information to a predetermined language to which translation is to be made on a basis of a translating condition; a server including: sorting means for sorting rule information relating to a predetermined category from the translated rule information on a basis of a sorting condition; simplifying means for forming concise information on a basis of predetermined information acquired from the sorted rule information; and progress-degree measuring means for measuring a progress degree of the rule creation on a basis of organization information including an organization serving as the collecting source of the rule information; and an SNS server that manages an SNS site for posting the concise information as a first post and includes: posting means for making the first post; and attention-degree measuring means for measuring an attention degree of corresponding rule information on a basis of at least one of a number of comments, a number of reactions, a number of clicks of links for accessing the corresponding rule information, and a number by which collapsed display is unfolded by the user corresponding to the concise information that is posted.

The “organization information” is a concept including information on an organization that is a collecting source from which rule information is collected. For example, when the collected rule information is content of a website, the information is information on an organization name, a group name, or the like that has created the content of the website. The “organization information” is a concept including information that can be converted to an organization name.

In an embodiment, Step S1 (see FIG. 5) corresponds to the “collecting means”.

In the embodiment, Step S3 (see FIG. 5) corresponds to the “translating means”.

In the embodiment, Step S5 (see FIG. 7) corresponds to the “sorting means”.

In the embodiment, Step S6 (see FIG. 7) corresponds to the “simplifying means”.

In the embodiment, Step S11 (see FIG. 7) corresponds to the “posting means”.

In the embodiment, Step v3 (see FIG. 15) corresponds to the “attention-degree measuring means”.

In the embodiment, Step w2 (see FIG. 16) corresponds to the “progress-degree measuring means”.

(7) A server of the present invention is a server, which forms information to be posted and in which an SNS site for posting a first post is prepared. The server includes: sorting means for sorting rule information, which is collected on a basis of a collecting condition including a collecting source registered in advance and which includes information relating to rule creation of an environmental issue, a human rights issue, a legal regulation, standardization, or the like published via the Internet, into rule information relating to a predetermined category on a basis of a sorting condition; and simplifying means for forming concise information on a basis of predetermined information acquired from the sorted rule information.

(8) The server as above preferably further includes progress-degree determining means for determining a progress degree of the rule creation on a basis of organization information including an organization serving as the collecting source of the rule information.

(9) An SNS server of the present invention manages an SNS site for posting a first post. The SNS server includes posting means for sorting, on a basis of a sorting condition, rule information relating to a predetermined category from rule information, which is collected on a basis of a collecting condition including a collecting source registered in advance and which includes information relating to rule creation of an environmental issue, a human rights issue, a legal regulation, standardization, or the like published via the Internet, and posting concise information formed by acquiring predetermined information from the sorted rule information on the SNS site as the first post.

(10) The SNS server as above preferably further includes requesting means for requesting addition of the collecting source so as to allow a user of the SNS to place the request.

In the embodiment, Step T1 (see FIG. 12) corresponds to the “requesting means”.

(11) The SNS server as above preferably further includes forum creating means for creating a forum on which specific users of the SNS are able to comment regarding the predetermined rule information so as to allow the users of the SNS to perform the creation.

In the embodiment, Step U4 (see FIG. 13) corresponds to the “forum creating means”.

(12) The SNS server as above preferably further includes attention-degree measuring means for measuring an attention degree of the concise information on a basis of at least one of a number of comments, a number of reactions, a number of clicks of links for accessing the corresponding rule information, and a number by which collapsed display is unfolded corresponding to the concise information that is posted.

(13) A server program of the present invention is a server program, which forms information to be posted and in which an SNS site for posting a first post is prepared. The server program causes a computer to: sort rule information, which is collected on a basis of a collecting condition including a collecting source registered in advance and which includes information relating to rule creation of an environmental issue, a human rights issue, a legal regulation, standardization, or the like published via the Internet, into rule information relating to a predetermined category on a basis of a sorting condition; and form concise information from the sorted rule information.

(14) The server program as above preferably further causes a progress degree of the rule creation to be determined on a basis of organization information including an organization serving as the collecting source of the rule information.

(15) An SNS program of the present invention is an SNS server program to be used in an SNS server that manages an SNS site for posting a first post and posts information to be posted on the SNS site. The SNS server program causes a computer to sort, on a basis of a sorting condition, rule information relating to a predetermined category from rule information, which is collected on a basis of a collecting condition including a collecting source registered in advance and which includes information relating to rule creation of an environmental issue, a human rights issue, a legal regulation, standardization, or the like published via the Internet, and post concise information formed by acquiring predetermined information from the sorted rule information on the SNS site as the first post.

(16) The SNS program as above preferably further causes an attention degree of the corresponding rule information to be measured on a basis of at least one of a number of comments, a number of reactions, a number of clicks of links for accessing the corresponding rule information, and a number by which collapsed display is unfolded corresponding to the concise information that is posted.

(17) The rule watch method as above is executed by one or a plurality of computers. The rule watch method includes: a step of collecting technical information relating to practical realization of technology such as technological investment or a press release relating to science and technology and academic technical information relating to a progress of technology such as a paper or a patent literature relating to science and technology from the Internet on a basis of a collecting condition registered in advance including a collecting source of the technical information and the academic information; a step of acquiring a co-occurrence word group from each of the rule information and the collected technical information and academic technical information; and a step of acquiring a similarity degree among information in the rule information, the technical information, and the academic information on a basis of a similarity degree of the each co-occurrence word group.

The “information relating to practical realization of the technology” is information relating to information for practical realization of knowledge in a specific field or information relating to the actual usage and utilization of a method of technologically applying scientific knowledge beyond the stage of experiments and theories. For example, the information is a press release relating to technology of a company, information relating to an in-house technology posted on an HP of a company, or information posted on an HP of a technology-based fund such as an HP of a public-private investment fund. The information does not necessarily need to directly relate to practical realization of technology. For example, the information may include information that eventually turns out to not relate to practical realization of technology and only needs to be information having a possibility of relating to practical realization of technology at the point of time of collection. The information is a concept including a value and information that can be converted to information relating to practical realization of technology. For example, the information is information on personnel, fund, and time necessary for practical realization of technology and development of element technology necessary for practical realization.

The “technical information” includes information relating to practical realization of technology and further includes information on text data and files, keywords (texts) for identifying document files from the inside of webpages, and metadata (for example, tag information of an HTML) associated with the document files, for example.

The “information relating to a progress of technology” includes information relating to studies necessary for the practical realization of technology and is information of published papers and literature of published patents, utility models, and the like in natural sciences such as astronomy, physics, chemistry, geoscience, and biology and engineering such as mechanical engineering, civil engineering, and electronics. The information does not necessarily need to directly relate to the progress of technology. For example, the information may include information that eventually turns out to not relate to the progress of technology and only needs to be information having a possibility of relating to the progress of technology at the point of time of collection. The information does not necessarily need to be information on the latest papers and literature and may include information on papers and literature of the past that turns out to be used in specific technology. The information is a concept including a value and information that can be converted to information relating to the progress of technology. For example, the information is a press release, public offering information, and the like of a public-private investment fund.

The “academic information” includes information relating to the progress of technology and further includes information on text data and files, keywords (texts) for identifying document files from the inside of webpages, and metadata (for example, tag information of an HTML) associated with the document files, for example.

(18) The rule watch method as above preferably further includes a step of displaying a magnitude of the similarity degree on a display unit of a user terminal in accordance with a thickness or a length of a line that connects similar display elements out of the display elements indicating the rule information, the technical information, and the academic information.

(19) The rule watch method as above preferably further includes: a step of sorting the collected rule information, technical information, and academic information into predetermined categories on a basis of a sorting condition; and a step of displaying a display element indicating the rule information, the technical information, or the academic information on a graph including an axis indicating a corresponding country or the category and a time axis.

(20) Another aspect of a rule watch method of the present invention is a rule watch method executed by one or a plurality of computers. The rule watch method includes: a step of collecting rule information relating to rule creation of an environmental issue, a human rights issue, a legal regulation, standardization, or the like, scientific and technical information relating to practical realization of technology such as technological investment or a press release relating to science and technology, and academic information relating to a progress of technology such as a paper or a patent literature relating to science and technology from the Internet on a basis of a collecting condition registered in advance including a collecting source of the rule information, the technical information, and the academic information; a step of acquiring a co-occurrence word group from each of the rule information and the collected technical information and academic technical information; and a step of acquiring a similarity degree among information in the rule information, the technical information, and the academic information on a basis of a similarity degree of the each co-occurrence word group.

(21) A user terminal of the present invention is communicably connected to a server. The server collects rule information relating to rule creation of an environmental issue, a human rights issue, a legal regulation, standardization, or the like, technical information relating to practical realization of technology such as technological investment or a press release relating to science and technology, and academic information relating to a progress of technology such as a paper or a patent literature relating to science and technology from the Internet on a basis of a collecting condition registered in advance, and sorts the rule information, the technical information, and the academic information by a predetermined sorting condition. The user terminal includes: operation-input-information acquisition means for acquiring operation input information including a country name or a technology theme name by operation of a user; and a display unit that displays a screen that is created by the server and indicates a number of the rule information, the technical information, or the academic information corresponding to the operation input information in time series.

In the embodiment, Step S13 (see FIG. 20) corresponds to the “input-information acquisition means”.

In the embodiment, Step S19 (see FIG. 24) corresponds to the “operation-input-information acquisition means”.

In the embodiment, Step S12 (see FIG. 19) corresponds to the “co-occurrence-word acquisition means”.

In the embodiment, Step S14 (see FIG. 20) corresponds to the “similarity-degree acquisition means”.

In the embodiment, Step S15 (see FIG. 20) corresponds to the “importance-degree acquisition means”.

In the embodiment, Step S17 (see FIG. 20) corresponds to the “person/organization importance degree means”.

In the embodiment, Step S16 (see FIG. 20) corresponds to the “screen creating means”.

In the embodiment, Step S21 (see FIG. 24) corresponds to the “collection-number acquisition means”.

In the embodiment, Step S22 (see FIG. 24) corresponds to “collecting screen acquisition means”.

In the embodiment, Step S23 (see FIG. 24) corresponds to the “display means”.

### Advantageous Effects of Invention

The rule watch system or the like of the present invention is capable of making the information relating to rule creation easier to grasp. The rule watch system or the like of the present invention is also capable of making the trend of technological investment and technological development of each country easier to grasp and the relationship between the rule information, the technical information, and the academic information easier to grasp.

### BRIEF DESCRIPTION OF THE DRAWINGS

FIG. 1 is a schematic view illustrating an environment in which a rule watch system is used.

FIG. 2 is a function block diagram illustrating one embodiment of the rule watch system.

FIG. 3 is a schematic view illustrating a hardware configuration of a server.

FIG. 4 is a schematic view illustrating one example of a hardware configuration of a user terminal.

FIG. 5 is a flowchart illustrating one embodiment of a flow of processing of the server.

FIG. 6 is a schematic view illustrating how the date of publication is set to a predetermined format.

FIG. 7 is a flowchart illustrating one embodiment of a flow of processing of the server.

FIG. 8 is a schematic view illustrating data structures of sorting tables indicating sorting conditions.

FIG. 9 is a schematic view showing a data structure of a classification table indicating classifying conditions.

FIG. 10 is a schematic view illustrating one embodiment of a screen displayed on a user terminal of an SNS user.

FIG. 11 is a schematic view illustrating one embodiment of a screen indicating a state in which the screen in FIG. 9 is in collapsed display.

FIG. 12 is a flowchart illustrating one embodiment of a flow of processing of an SNS server.

FIG. 13 is a flowchart illustrating one embodiment of a flow of processing of the SNS server.

FIG. 14 is a schematic view illustrating one embodiment of a full screen displayed on the user terminal of the SNS user.

FIG. 15 is a flowchart illustrating one embodiment of a flow of processing of the SNS server.

FIG. 16 is a flowchart illustrating one embodiment of a flow of processing of the server.

FIG. 17 is a schematic view illustrating one example of stages of the progress degree of rule creation.

FIG. 18 is a function block diagram illustrating another embodiment of a rule watch system.

FIG. 19 is a flowchart illustrating one embodiment of a flow of processing of the server and an analysis server.

FIG. 20 is a flowchart illustrating one embodiment of a flow of processing of the analysis server.

FIG. 21 is a correlation diagram indicating the relationship between rule information, technical information, and academic information.

FIG. 22 is a schematic view showing one embodiment of display elements, link display elements, person/organization display elements, and person link display elements.

FIG. 23 is a person correlation diagram indicating the relationship among rule information, technical information, academic information, and person/organization information.

FIG. 24 is a flowchart illustrating one embodiment of a flow of processing of the user terminal and the analysis server.

FIG. 25 is a schematic view illustrating one embodiment of a trend screen displayed on the user terminal.

FIG. 26 is a schematic view illustrating another embodiment of a trend screen displayed on the user terminal.

### DETAILED DESCRIPTION OF THE INVENTION

### 1. Brief Description

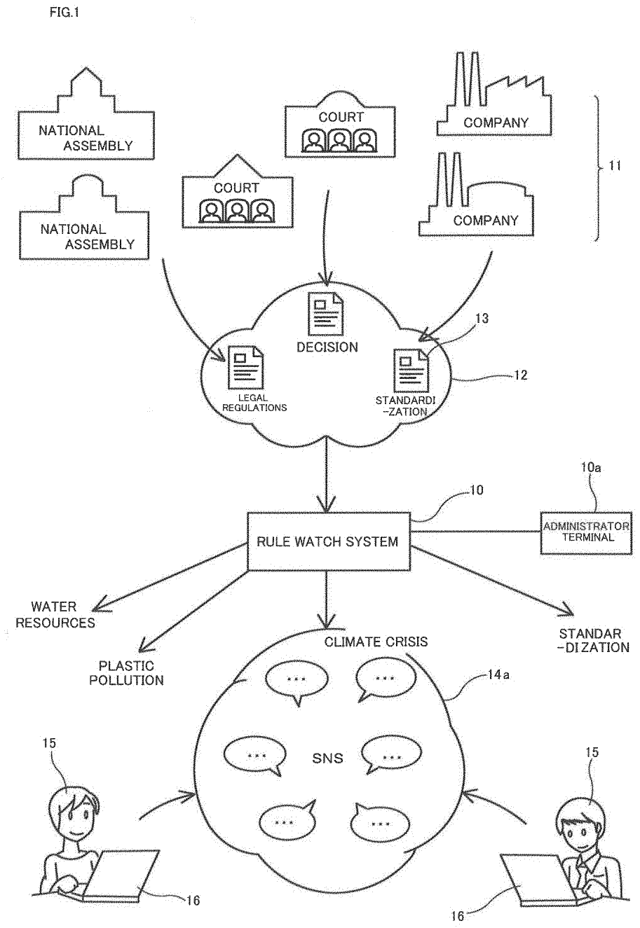

First, a rule watch system of the present invention is described with reference to FIG. 1. A rule watch system (hereinafter referred to as a system) 10 illustrated in FIG. 1 collects information 13 relating to rule creation at home and abroad in terms of environmental issues, human rights issues, standardization of technology, legal regulations, and the like from collecting sources 11 via the Internet 12. In general, the information 13 relating to rule creation is formed by various formats, is cumbersome, and contains specialized content, and hence tends to be known by limited people and difficult to understand.

The present system 10 simplifies the information 13 relating to rule creation at home and abroad and posts the information 13 on a site 14a of a social network service (SNS) prepared for posting the information 13. In general, the SNS has functions of submitting, sharing, and spreading information. Therefore, it becomes possible to encourage companies, researchers, and citizens as users 15 in various positions belonging to the SNS to deal with social issues by an outside-in approach crossing fields in a cross-cutting manner.

The users 15 can easily come into contact with the information 13 relating to rule creation and can submit comments or share and spread comments and the information 13. For example, the content of a comment, an expression of an attitude by a reaction, the number of comments regarding specific rule creation indirectly indicate reactions such as an interest, doubt, vigilance, and the like against the rule creation. By observing the reactions of those SNS users 15, it becomes possible to notice important rule creation signs such as whether the rule creation is rule creation to be welcomed or is rule creation that requires vigilance, and global rule creation can be monitored by the SNS users.

(Rule Watch System 10)

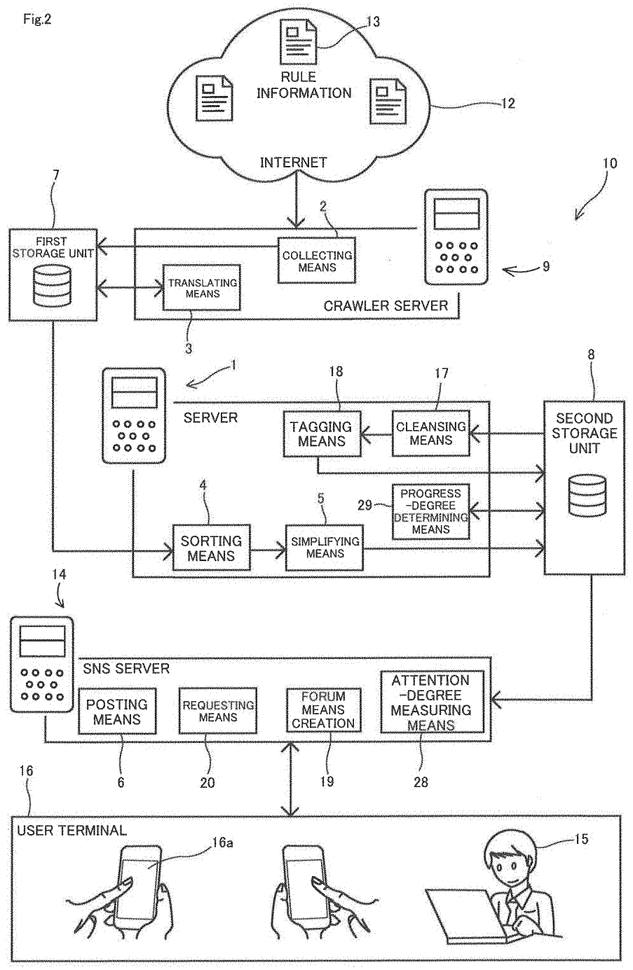

The system 10 according to one embodiment of the present invention is described with reference to a function block diagram of FIG. 2. The system 10 illustrated in FIG. 2 is formed by a crawler server 9 that collects the rule information 13 on the Internet 12, a server 1 that acquires the rule information collected by the crawler server 9, and an SNS server 14 communicably connected to the server 1 via the Internet 12 (communication network) and the like. In the present embodiment, an administrator terminal 10a (see FIG. 1) operated by an administrator is communicably connected to the system 10. The administrator terminal 10a transmits modifications of programs, conditions, and the like to the crawler server 9, the server 1, and the SNS server 14 by the administrator.

In the present embodiment, a first storage unit 7 and a second storage unit 8 are included as external data servers.

(Collecting Source 11)

In the present embodiment, websites of assemblies of major countries, public administrations, supreme courts, the United Nations, research institutes, and major NGOs, for example, are equivalent to the collecting sources 11 (see FIG. 1). In addition to the above, websites of companies determined to be relating to academic information, technology investment information, and rule creation may be included.

(Rule Information 13)

The rule information 13 includes text data, image data, moving image (video) data, audio (sound recording data) data, files thereof, text files, image files, moving image (video) files, audio (sound recording data) files, and the like published on websites, SNSs, and the like serving as the collecting sources 11, for example. In addition to the above, mail magazines and transcription information from moving-image audio data may be included.

### 2. Each Configuration

### (Server 1)

FIG. 2 illustrates one embodiment of the crawler server 9. In the present embodiment, the crawler server 9 is a personal computer, for example. The crawler server 9 illustrated in FIG. 2 includes collecting means 2 and translating means 3.

(Collecting Means 2)

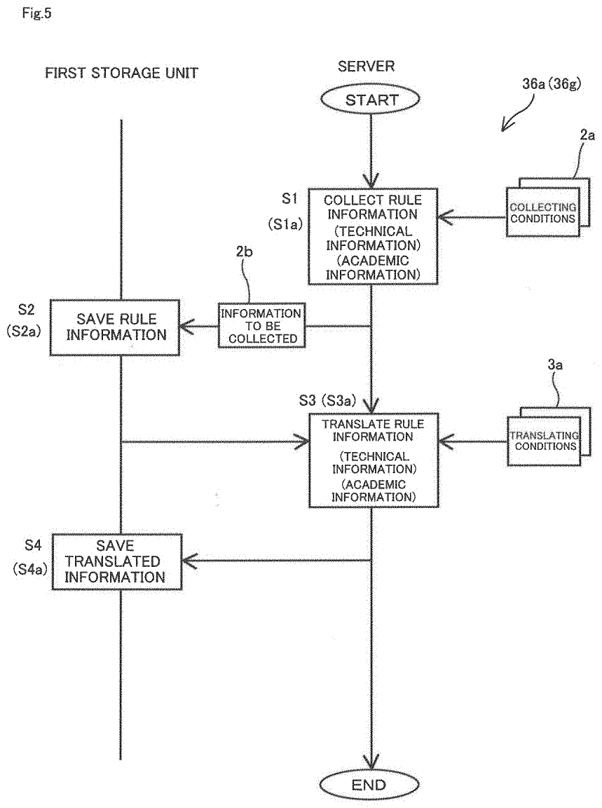

The collecting means 2 collects the rule information 13 on the basis of collecting conditions 2a (see FIG. 5). The collecting means 2 is a so-called crawler, for example, and collects text data from predetermined sites such as websites and SNSs. The text data contains text content of the website and metadata. The metadata is data that is not displayed to a reader of the content on a web browser and includes information such as a title, the length of a content document, a creator, an organization name, the date of publication, the date and time of creation, the date and time of update, keywords, a summary of the content document, and a simplified version of the summary, for example.

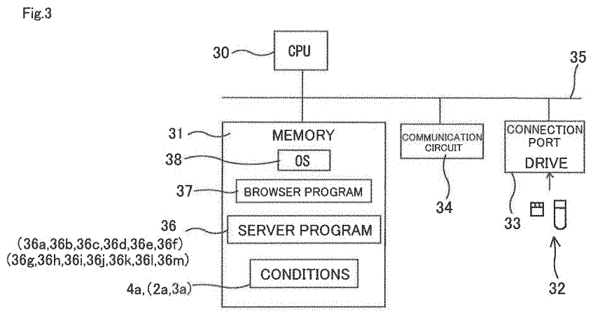

The collecting conditions 2a are stored in a memory of the crawler server 9 (see FIG. 3). In the collecting condition 2a, URLs of sites to be collected are described. Regarding the information to be collected, whether the text information, the title, the organization name, and the date of publication, for example, are to be acquired from the content of the website or from the metadata is defined for each site by the collecting condition 2a.

(Translating Means 3)

The translating means 3 translates the rule information 13 into a predetermined language on the basis of translating conditions 3a. The translated rule information 13 is stored into the first storage unit 7. In the present embodiment, languages other than English are translated into English. As the translating means 3, a well-known translating program of the related art may be used. The translating means may perform translation into other languages such as Japanese. The rule information 13 gathered from countries around the world is translated into a predetermined language, in other words, a common language. A series of processing of sorting means 4 and thereafter is performed on the basis of the common language.

(Translating Conditions 3a)

The translating conditions 3a are stored in a storage unit of the server 1 (see FIG. 3). As the translating condition 3a, a dictionary table for translating technical terms and the like is included, for example. In addition to the above, a dictionary table for eliminating variations in organization names and abbreviations therefor, a dictionary table for eliminating variations in confederations of states and names of countries, and the like are included.

(Server 1)

FIG. 2 illustrates one embodiment of the server 1. In the present embodiment, the server 1 is a personal computer, for example. The server 1 illustrated in FIG. 2 includes the sorting means 4 and simplifying means 5. In the present embodiment, the server 1 further includes cleansing means 17, tagging means 18, and progress-degree determining means 29.

(Sorting Means 4)

The sorting means 4 sorts the rule information relating to a predetermined category from the translated rule information 13 on the basis of sorting conditions 4a.

(Sorting Conditions 4a)

The sorting conditions 4a are stored in the storage unit of the server 1 (see FIG. 3). In the sorting conditions 4a, keywords for the sorting are registered. In the present embodiment, the sorting conditions 4a are created by a language to which translation is made, in other words, English.

(Simplifying Means 5)

The simplifying means 5 forms concise information 5a on the basis of predetermined information acquired from the sorted rule information 13.

(Cleansing Means 17)

The cleansing means 7 performs data cleansing processing. The cleansing means 7 finds overlaps, notation variations, and the like from data including the rule information 13 stored in the second storage unit 8 and performs deletion, modification, normalization, and the like. The cleansing means 7 may find a scribal error and perform deletion, modification, normalization, and the like.

(Tagging Means 18)

The tagging means 18 classifies the keywords acquired by the simplifying means 5 to predetermined topics on the basis of classifying conditions 18a. Next, the tagging means 18 tags the rule information 13 with the topics and stores the tagged rule information 13 in the second storage unit 8.

(Progress-Degree Determining Means 29)

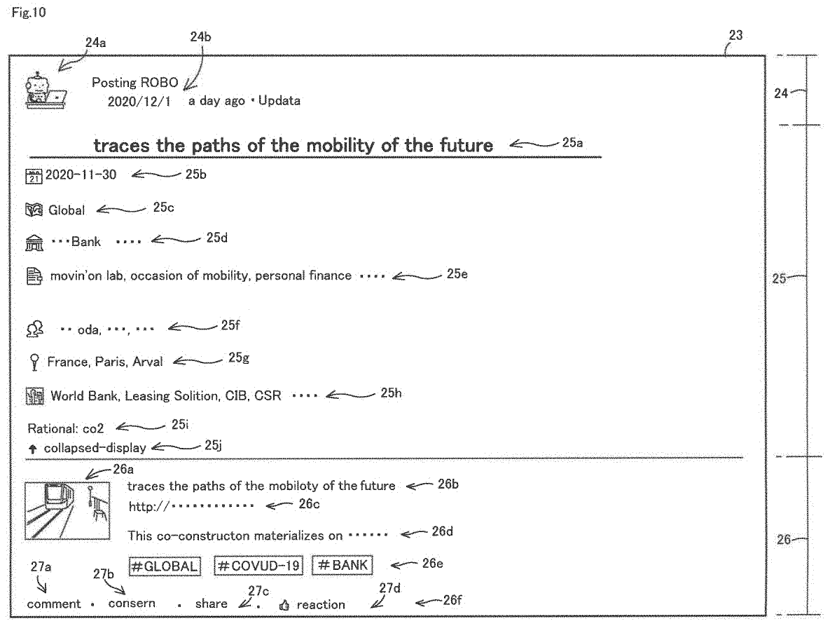

The progress-degree determining means 29 determines the progress degree of the rule creation on the basis of an organization (reference character 25d in FIG. 10) that is the collecting source 11 (see FIG. 1) of the rule information 13.

(SNS Server 14)

In the present embodiment, the SNS server 14 is a personal computer, for example. The SNS server 14 manages an SNS site 14a (see FIG. 1). The SNS server 14 includes posting means 6, forum creating means 19, requesting means 20, and attention-degree measuring means 28.

(SNS Site 14a)

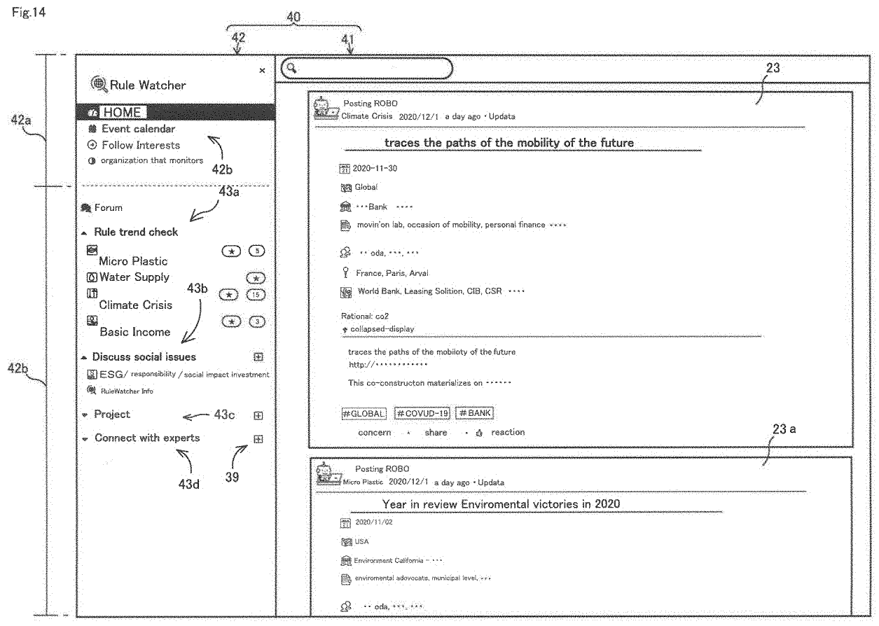

The SNS is an abbreviation of a “social networking service”. The SNS is normally a members-only service of a website on which users can interact with each other. In a typical SNS, a page on which personal profiles and photographs are posted can be owned. The page has a message function, a chat function, a group function (see forums with reference character 43a and the like in FIG. 14) with which information, files, and the like can be exchanged within a specific group of people, and the like. In addition to the above, a diary function and the like of which range of being open to the public can be limited are prepared, and the functions can be expanded by installing applications. Upon usage, the user may be required to perform a predetermined registration.

The SNS site 14a used in the present embodiment is a site on a web on which users can interact with each other. For example, the SNS site 14a has a function (see reference character 27a in FIG. 10) of commenting on the concise information 5a, a function (see reference character 27b in FIG. 10) of selecting a preregistered comment that the user is conceived to be concerned about, a function (see reference character 27c in FIG. 10) of sharing to other SNSs, and a function (see reference character 27d in FIG. 10) of reacting to a comment or the concise information 5a.

(Posting Means 6)

The posting means 6 posts the concise information 5a on the SNS site 14a as the first post for each category sorted by the sorting means 4. The first post means to post a thread on the SNS site 14a. In the present embodiment, the posting means 6 posts the concise information 5a as a thread for each category.

(Forum Creating Means 19)

The forum creating means 19 creates a forum on which specific SNS users 15, 15 can comment on the basis of a forum creating operation by the SNS user 15.

(Requesting Means 20)

The requesting means 20 transmits the addition of a desired collecting source of the rule information 13 to the crawler server 9 on the basis of a requesting operation by the SNS user 15. The addition of the collecting source may be transmitted to the administrator terminal 10a and may be transmitted to the crawler server 9 after the confirmation of the administrator.

(Attention-Degree Measuring Means 28)

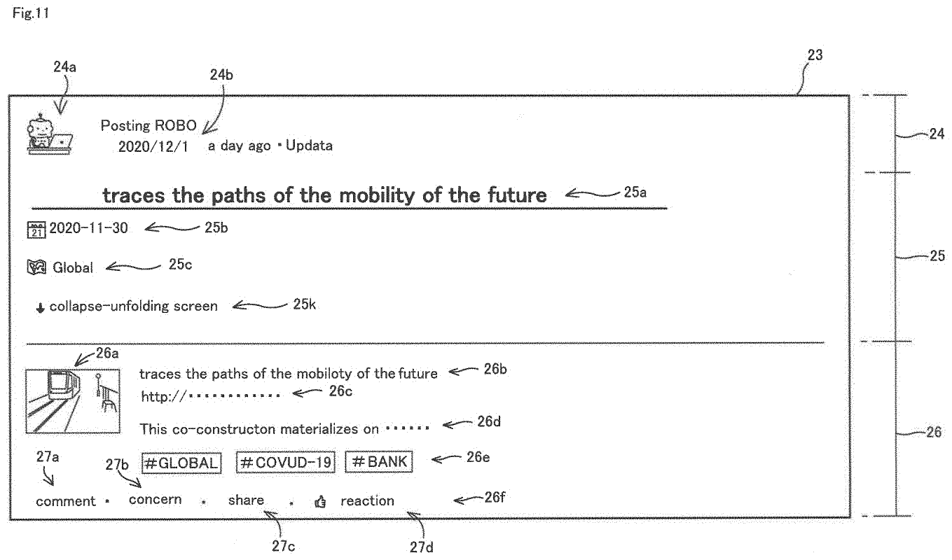

The attention-degree measuring means 28 measures the attention degree of the corresponding rule information on the basis of at least one of the number of comments, the number of reactions, the number of clicks of links for accessing the corresponding rule information, and the number by which collapsed display (see FIG. 11) is unfolded by the user 15 corresponding to the posted concise information 5a.

(User Terminal 16)

The user terminal 16 includes a display unit 16a. In the present embodiment, the user terminal 16 is a smartphone, for example. The user terminal 16 may be a mobile phone, a tablet-type terminal, a personal computer, or the like.

(Display Unit 16a)

As the display unit 16a, an apparatus that displays a screen of a liquid crystal display (LCD), a plasma display panel (PDP), an organic electroluminescence (EL), or the like is used, for example. The user 15 can operate the user terminal 16 by pressing or touching the display unit 16a with a finger or a thumb and the like. The user terminal 16 can acquire information (described later) to be input via the user 15 by the operation.

### 3. Hardware Configuration

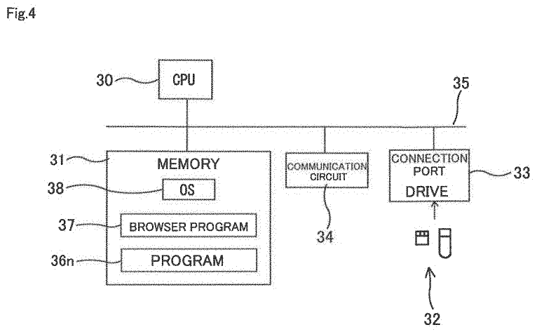

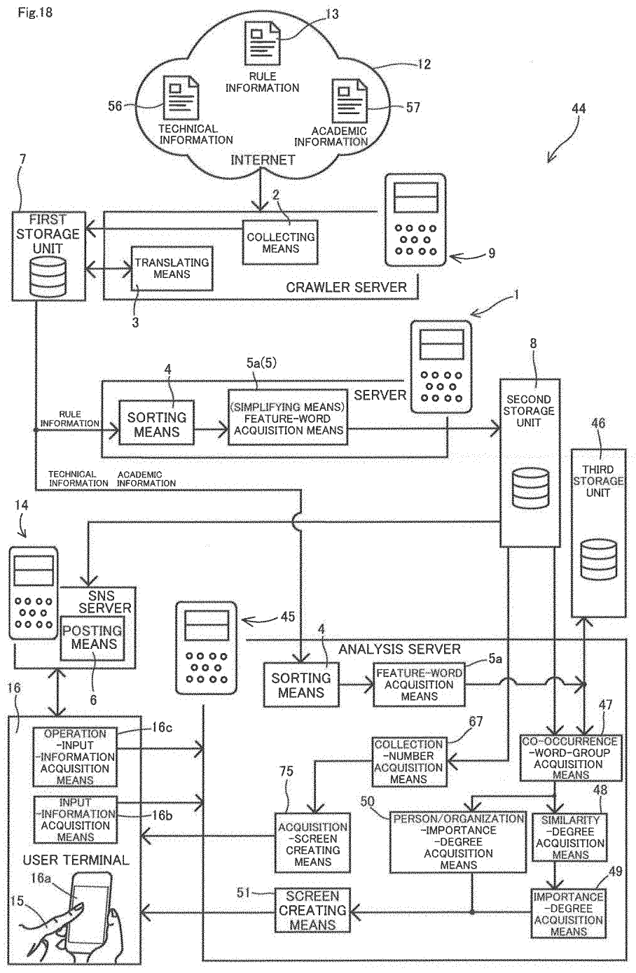

Next, hardware configurations of the server 1, the crawler server 9, and the SNS server 14, in other words, the servers 1, 9, 14 and a server 45 (described later in FIG. 18) are described with reference to FIG. 3. A hardware configuration of the user terminal 16 is described with reference to FIG. 4.

(Hardware Configuration of Server 1 (9, 14, 45))

For example, a personal computer is used as the server 1, (9, 14, 45) of the present embodiment. As illustrated in FIG. 3, the personal computer includes a CPU 30. A memory 31, a connection port 33 for connecting/reading a recording device 32 and the like, and a communication circuit 34 for communicating with the outside over a network are connected to the CPU 30 via a bus line 35. In the memory 31, the conditions 4a, (2a, 3a), server programs 36 (36a to 36m) for processing the system of the present invention, a browser program 37, and an operating system (OS) 38 are recorded.

In the present embodiment, the server program 36 operates in cooperation with use of functions of the OS 38 and the browser program 37. The server program 36 may independently operate without the use of the browser program 37 and the OS 38. The conditions 4a, (2a, 3a), the server program 36, the browser program 37, and the OS 38 are installed into the memory 31 via the communication circuit 34 by downloading or by the device 32 through the connection port 33, for example.

(Hardware Configuration of User Terminal 16)

Next, the hardware configuration of the user terminal 16 is described with reference to FIG. 4. The hardware configuration of the user terminal 16 illustrated in FIG. 4 is substantially the same as the hardware configuration of the server 1 described above, and hence the same parts are denoted by the same reference characters and description thereof is omitted. Reference character 36n is a program of the user terminal.

In the hardware configuration described above, the functions illustrated in FIG. 2 and FIG. 18 are realized with use of the CPU 30 and the program 36, for example, but a part or all of thereof may be sequentially controlled by a logic circuit such as a microcontroller or a programmable logic controller (PLC).

### 4. Program

### (Flowchart of Acquiring Rule Information 13)

FIG. 5 is a flowchart illustrating one embodiment of processing of the crawler program 36a used in the crawler server 9 of the system 10. FIG. 5 is mainly a flowchart of acquiring the rule information 13. The technical information and the academic information are described later.

(S1) The CPU 30 (see FIG. 3) of the crawler server 9 collects the rule information 13 on the basis of the collecting conditions 2a from webpages published on the Internet 12. In the present embodiment, text data and files are collected as the rule information 13. Text information, titles, organization names, dates of publication are extracted from the text data, the files, and the like as information 2b to be collected. As the information 2b to be collected, URLs of gathering sources are acquired in accordance with the collecting conditions 2a.

The text information is a text content of a website, and the title is a title given to the text data. The organization name is an entity that has published the text data, and is an individual, a group, a company, or the like. The date of publication is the date on which the text data is published on the Internet.

In addition to the above, tag information, event information, trial status information, and the like may be collected as keywords of the text content.

(S2) The collected rule information 13 is stored into the first storage unit 7. At this time, the information 2b to be collected is stored into the first storage unit 7 by being linked to the collected rule information 13.

Conditions for saving the collected rule information 13 in the first storage unit 7 are defined in the collecting conditions 2a. In the present embodiment, for example, it is checked whether information of which title, date of publication, and organization name entirely match with the title, the date of publication, and the organization name acquired from the acquired rule information 13 is present in the first storage unit 7, and the storage is performed when there are no such information. As a result, a case where the same pieces of writing are collected is prevented.

(S3) The rule information 13 is acquired from the first storage unit 7 and is translated into English on the basis of the translating conditions 3a. The information 2b to be collected may be translated into a predetermined language.

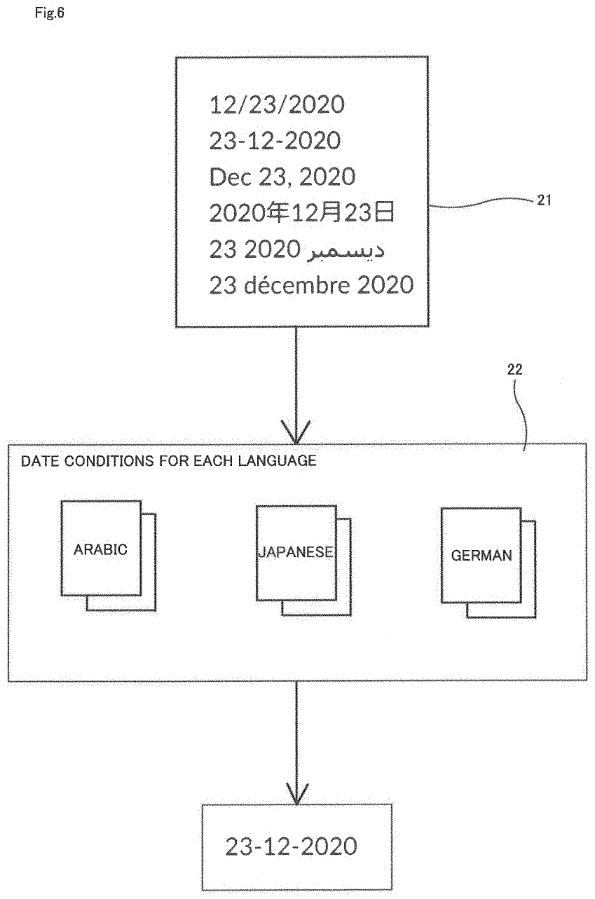

Next, FIG. 6 is a schematic view illustrating how the date of publication is set to a predetermined format. As illustrated in FIG. 6, various data 21 of the date of publication is set to a predetermined format on the basis of a date table 22 provided for each language and is stored into the first storage unit 7. The date table 22 is included in the collecting conditions 2a.

(S4) The translated rule information 13 is stored into the first storage unit 7.

(Flowchart of Simplifying and Posting Rule Information 13)

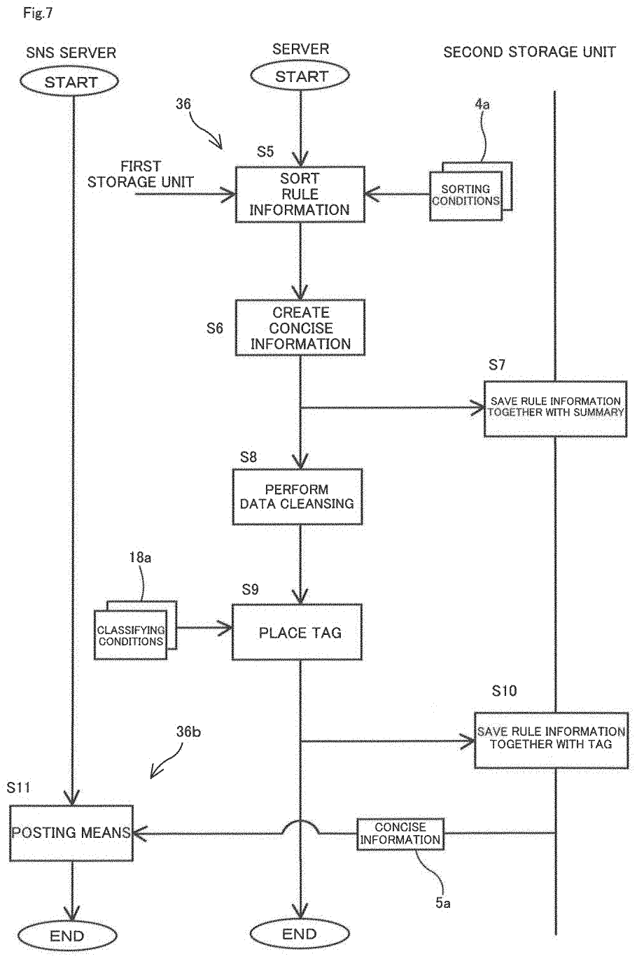

FIG. 7 is a flowchart illustrating one embodiment of processing of the server program 36 and the SNS server program 36b used in the server 1 and the SNS server 14, respectively. FIG. 7 is mainly a flowchart of simplifying and posting the rule information 13.

(S5) The rule information 13 is acquired from the first storage unit 7, and the rule information 13 relating to a predetermined category is sorted on the basis of the sorting conditions 4a.

In the present embodiment, for example, the rule information 13 relating to a category of climate crisis is sorted from the rule information 13 (see FIG. 1). The sorted rule information 13 is tagged with a tag (category) 4b (described next) of climate crisis. The rule information 13 is separated by category.

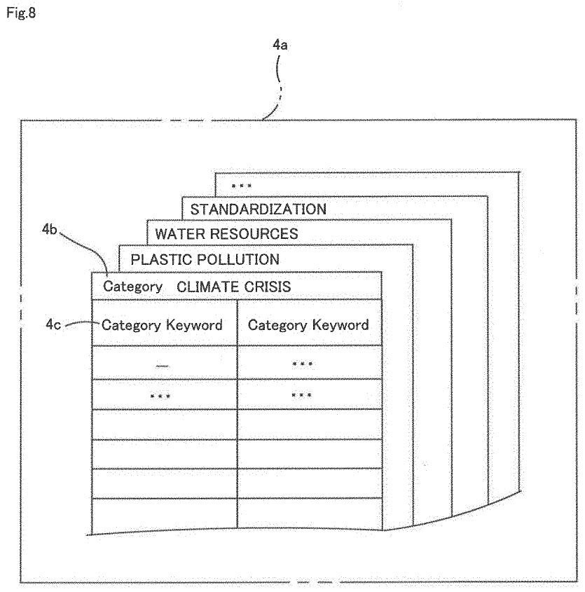

FIG. 8 is a view illustrating data structures of sorting tables indicating the sorting conditions 4a. Regarding the sorting tables illustrated in the drawing, a table is prepared for each category 4b. A sorting table when the category is climate crisis is illustrated in the drawing.

On the sorting table, one or more of specific category keywords 4c are described (simply referred to as the keyword 4c) for one category 4b. When the specific keyword 4c is present in the text information of the rule information 13, the corresponding category 4b is determined on the basis of the sorting table. In the present embodiment, there are a case where the category 4b is determined as a result of one keyword 4c being present in the text information of the rule information 13, and a case where the category 4b is determined as a result of a set of two keywords 4c being present in the text information of the rule information 13. The category 4b may be determined as a result of three or more keywords 4c being present in the text information of the rule information 13.

(S6) Returning to FIG. 7, the concise information 5a is created from the rule information 13. In the present embodiment, keywords are extracted from the text information of the rule information 13 by machine learning, and a summary and text information (hereinafter referred to as a simplified summary text) with a predetermined number of characters in the beginning of the summary are created.

Examples of keywords to be extracted include the title of the rule information 13, the organization name serving as the collecting source 11, the date of publication, the target (target country) of the article, and a personal name, a geographical name, and an organization name extracted from the text information of the rule information 13. The personal name, the geographical name, and the organization name may be in a plurality of numbers. The URL of the collecting source 11 is acquired from the information 2b to be collected. In addition to the above, names of laws and regulations may be extracted. The title, the organization name, and the date of publication may be acquired from the information 2b to be collected (see FIG. 5).

Regarding the extraction of the keywords described above, machine learning is used, for example. In other words, machine learning on the inference of whether the keyword belongs to the extracted keyword type is performed. A computation model on which learning has been applied can analogize the keyword type that a keyword corresponds to and classify the keyword even when the keyword is a word at first sight. The computation model has a function of scoring and simultaneously indicating the similarity degree as the confidence degree of the word analogy and can be programmed so as not to adopt the word analogy when the score is too low.

For example, an approach of generating a computation model relating to the extraction of the “organization name” is described. First, a plurality of data corresponding to keyword types to which classification is to be made such as “organization name”, “personal name”, “words relating to law”, and the like or data corresponding to none of the above is prepared in advance as learning data in a format of being paired with keyword-type label information. Language data (character data) is handled in the present case, and a computer (calculator) cannot interpret the language data as it is. Therefore, the language data is converted into a combination of numeric data, in other words, vectors. When the vectors of similar learning data are input to the computation model, the computation model calculates and outputs a fit certainty factor of the input vectors with respect to the classifying type. The vectors output as a result are numerical values (certainty factors) indicating the similarity degree of the classifying type. Meanwhile, when a plurality of learning data that are not similar is input, vectors indicating that the corresponding classification does not correspond to the learning data are generated. Regarding the output result thereof, modification and optimization of the computation model are performed such that the certainty factor with respect to label information that forms a pair with all of the input data increases. In the computation model generated as above, the selection of input data that provides an output of which certainty factor of the “organization name” is high is the extraction of the “organization name”, in other words.

It is also possible to perform machine learning in a general-purpose computer outside of the system of the present case, as needed, when learning data is prepared for the keyword types. The keyword extraction of the system of the present case can be optimized, as appropriate, by switching the computation model used in the system of the present case to a separately-generated computation model of which analogical accuracy of classification is increased.

In the present embodiment, the concise information 5a is formed by the date of publication, a title, a country name/organization name in which the content is published, geographical names, personal names, and keywords extracted from the content, an URL of the website, and a simplified summary text obtained by simplifying a summary. Other information may be added.

(S7) The concise information 5a is linked to the rule information 13 and is stored into the second storage unit 8 with the rule information 13.

(S8) The rule information 13 is acquired from the second storage unit 8, and data cleansing is performed.

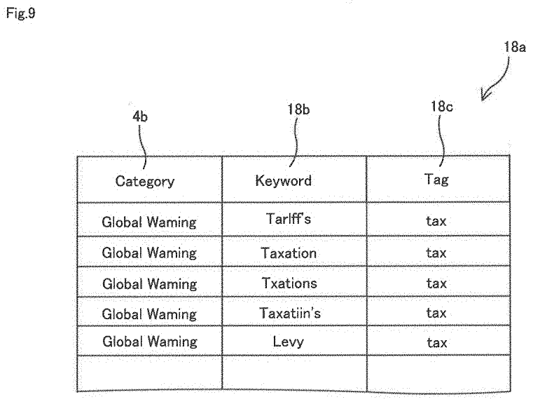

FIG. 9 shows a data structure of a classification table indicating the classifying conditions 18a. The classifying table 18a shown in the drawing is formed by the categories 4b, keywords 18b, and tags 18c corresponding to the keywords 18b.

(S9) Returning to FIG. 7, the keywords extracted in Step S6 are classified into the tags 18c indicating predetermined topics on the basis of the classifying conditions 18a.

(S10) The tagged rule information 13 is stored into the second storage unit 8.

(S11) The CPU of the SNS server 14 acquires the concise information 5a from the second storage unit 8 and posts the concise information 5a on the SNS site 14a as the first post. In other words, the concise information 5a is posted for each category 4b as a thread on the SNS site 14a.

FIG. 10 is a schematic view illustrating one embodiment of the screen 16a displayed on the user terminal 16 of the SNS user 15. A posting screen 23 is illustrated in FIG. 10. The posting screen 23 is divided into three parts, in other words, an upper stage, an intermediate stage, and a lower stage. The upper stage is a common screen portion 24, the intermediate stage is an extracted-keyword screen portion 25, and the lower stage is a summary screen portion 26.

(Common Screen Portion 24)

The common screen portion 24 is formed by a poster screen portion 24a indicating a poster, and a posting date/time screen portion 24b indicating the posting date and time. An automatic posting robot (SNS server program 36b) is the poster in the embodiment.

(Extracted-Keyword Screen Portion 25)

The extracted-keyword screen portion 25 is formed by a title screen portion 25a in which the title of the rule information 13 is displayed, a screen portion 25b indicating the date of publication of the rule information 13, a screen portion 25c indicating the target (target country) of the article, a screen portion 25d indicating the organization name of the rule information 13, a screen portion 25e indicating the keywords 18b extracted from the rule information 13, a screen portion 25f indicating personal names extracted from the rule information 13, a screen portion 25g indicating extracted geographical names, a screen portion 25h indicating extracted organization names, a screen portion 25i indicating the keyword 4c serving as the evidence of the sorted category 4b (see FIG. 8), and a collapsed-display screen portion 25j that is a section to be clicked and is for displaying the display of the screen portions of reference characters 25d to 25i in a collapsed manner.

(Title Screen Portion 25a)

The title screen portion 25a is linked to a homepage (HP) of the collecting source 11 of the rule information 13.

(Summary Screen Portion 26)

The summary screen portion 26 is formed by an icon screen portion 26a that displays an icon and the like indicating the collecting source 11, a title screen portion 26b that displays the title, an URL screen portion 26c that displays an URL, a simplification screen portion 26d that displays the simplified summary text, a tag screen portion 26e that displays the tags 18c (see FIG. 9), and an input screen portion 26f to which input is to be made by the user.

The icon screen portion 26a, the title screen portion 26b, and the URL screen portion 26c are linked to the homepage (HP) of the collecting source 11.

The tag screen portion 26e displays the rule information 13 of the same tag 18c in a sorted manner when being clicked.

The input screen portion 26f is a portion to which input is to be made by the user 15, and a reaction on the posted rule information 13 is input thereto. For example, the above is referred to as an action by the user.

Reference character 27a indicates a screen portion for entering a comment. When the comment screen portion 27a is clicked, a comment entry field is displayed. A comment can be entered by the user 15.

Reference character 27b indicates a concern screen portion indicating a concern. When the concern screen portion 27 is clicked, a plurality of comments conceived to be concerned by the user are listed. Comments conceived to be matching are clicked by the user 15.

For example, the comments are as follows.
It may be irrelevant to the topic . . .
It feels uncomfortable . . .
It may be a spam
It may be fake news . . .
It may be a fraud . . .
It may be a banned post . . .
It may be violent . . .

Something is lacking in the entered information. (For example, it says “NAN”) Concerns besides the above that the administrator should know

Reference character 27c indicates a share screen portion for performing sharing. When the share screen portion 27c is clicked, the concise information 5a or information relating to the concise information 5a can be shared to other SNSs registered by the user 15. For example, information displayed on the summary screen portion 26 is shared.

Reference character 27d indicates a reaction screen portion indicating a reaction. When the reaction screen portion 27d is clicked, a plurality of illustration screens indicating feelings conceived to be felt by the user are listed. When an illustration screen conceived to be matching is clicked by the user 15, the number of clicks is displayed together with the illustration screen. A number is added each time the same screen is clicked.

For example, feelings indicated by the illustration screens are as follows.
Like (indicating “good”)
Fascinating (indicating deep emotion)
Haha (indicating laughter)
NICEWATCH (indicating a feeling of wanting to pay attention to the target as a target of rule watching)
Wow (indicating surprise)
Sob (indicating sadness)
Huff (indicating anger)

A post is made on the SNS site 14a once a day at a predetermined time, for example. At this time, the server 1 transmits the simplified summary text (see reference character 26d in FIG. 10) corresponding to the posted concise information 5a to an e-mail address of the SNS user 15. As a result, the user 15 is notified that a post has been made. A post may be made a plurality of times in one day.

FIG. 11 is a schematic view illustrating one embodiment of a screen indicating a state in which the screen in FIG. 10 is in collapsed display. Reference character 25k indicates a collapse-unfolding screen portion. When the collapse-unfolding screen portion 25k is clicked, the screen portions (see FIG. 10) of reference characters 25d to 25i are displayed.

(Flowchart of Requesting Collecting Source of Rule Information 13)

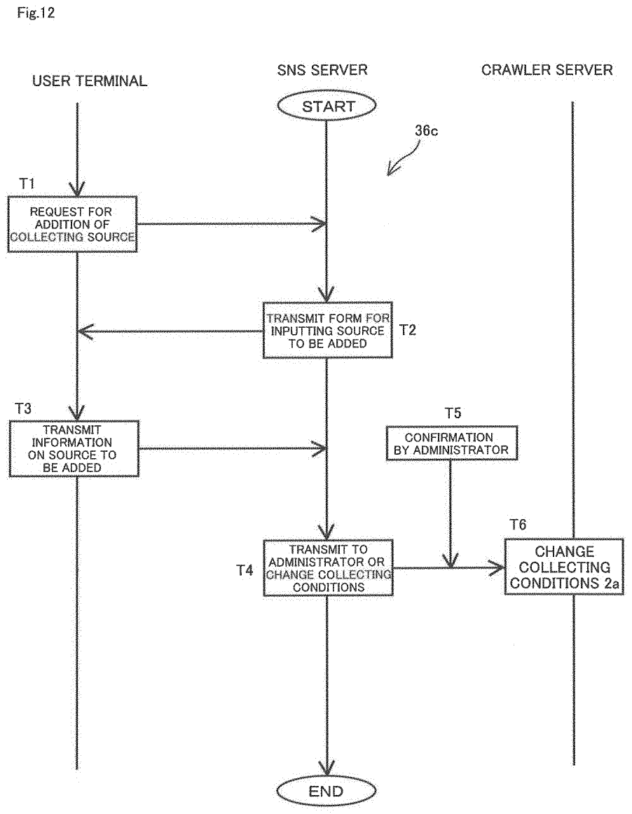

FIG. 12 is a flowchart illustrating one embodiment of processing of the SNS server program 36c used in the SNS server 14. FIG. 12 is mainly a flowchart of requesting the collecting source of the rule information 13.

(T1) A requesting command for a form for adding the collecting source 11 is transmitted to the SNS server 14 from the user terminal 16. For example, a button for the addition may be provided on a full screen (see FIG. 14), and a command requesting a form may be given by clicking the button.

(T2) A form for adding the collecting source 11 is transmitted to the user terminal 16 from the SNS server 14.

(T3) Information on the collecting source is input by the user 15. The input information on the collecting source is transmitted to the SNS server 14.

(T4) The information on the collecting source is transmitted to the administrator terminal 10a (see FIG. 1).

(T5) The collecting source is confirmed by the administrator.

(T6) The confirmed collecting source is transmitted to the crawler server 9 and is added to the collecting conditions 2a (see FIG. 5).

(Flowchart of Requesting Forum Creation)

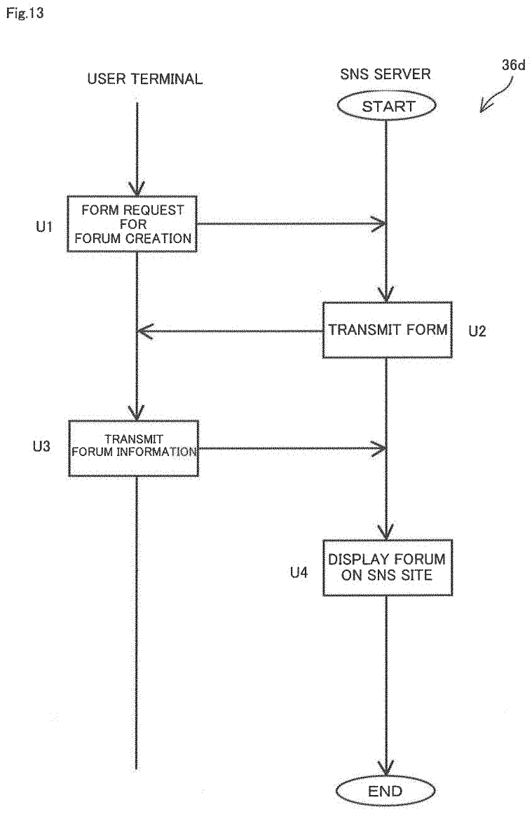

FIG. 13 is a flowchart illustrating one embodiment of processing of the SNS server program 36d used in the SNS server 14. FIG. 13 is mainly a flowchart of requesting the creation of a forum. In order to facilitate understanding of the creation of a forum, a home screen (full screen) is described first.

FIG. 14 is a schematic view illustrating one embodiment of the full screen displayed on the user terminal 16 of the SNS user 15. A full screen 40 is illustrated in FIG. 14. The full screen 40 is divided into a left part and a right part. The full screen 40 is formed by a right screen 41 and a left screen 42. In the right screen 41, the posting screen 23 is displayed in time series. When the right screen 41 is scrolled downward, a posting screen 23a posted in the past is displayed.

(Outer Left Surface Portion 42)

The left screen 42 is formed by a common screen portion 42a and a forum screen portion 42b.

(Common Screen Portion 42a)

White characters of “Home” on a colored background in the common screen portion 42a indicate that the home screen (full screen) is currently selected. For example, when an event calendar 42b is selected, a calendar is displayed on the right screen 41 (not shown).

(Forum Screen Portion 42b)

In the forum screen portion 42b, a forum that is already created is displayed. The forum screen portion 42b is formed by a rule-trend screen portion 43a, a social-issue screen portion 43b, a project screen portion 43c, and an expert screen portion 43d.

(Rule-Trend Screen Portion 43a)

In the present embodiment, four forums are created as the rule-trend screen portion 43a. Each forum is organized in accordance with each category 4b (see FIG. 9). For example, when “Climate Crisis” is clicked, the concise information 5a (see FIG. 7) of which category is “Climate Crisis” is displayed. Those forums are created by the administrator. Those forums may be created by the SNS user 15.

(Social-Issue Screen Portion 43b)

The social-issue screen portion 43b is a forum to be created by the SNS user 15. The social-issue screen portion 43b is a room where the SNS users 15, 15 hold a discussion with each other on a common problem. For example, when “ESG/Responsibility/Social Impact Investment” in the drawing is clicked, a chat room is displayed on the right screen 41.

(Project Screen Portion 43c)

The project screen portion 43c is a forum created when the conversation progresses among the users on a forum created in the social-issue screen portion 43b, and effort is specifically made as a project, for example.

(Expert Screen Portion 43d)

The expert screen portion 43d is a forum in which the SNS users 15 and experts talk with each other.

Returning to FIG. 13, (U1) a requesting command for a form for forum creation is transmitted to the SNS server 14 from the user terminal 16.

As illustrated in FIG. 14, a display screen portion (see reference character 39) of “+” on the right side of the social-issue screen portion 43b, the project screen portion 43c, and the expert screen portion 43d is an addition screen portion 39 for requesting the creation of a forum. A command requesting a form is given by clicking the addition screen portion 39.

Returning to FIG. 13 again, (U2) the form for forum creation is transmitted to the user terminal 16 from the SNS server 14.

(U3) Information for the creation is input to the forum by the user 15. The input information is transmitted to the SNS server 14.

For example, the input information is as follows.
Forum name
Description of the forum
Settings regarding the range by which the forum is open to the public (for example, whether the range is limited to the SNS users or whether browsing restrictions are applied)
How the content is seen (for example, whether the content is limited to forum members or whether browsing restrictions are applied)
Participating method (whether the method is invitation only, whether the method is invitations and requests, and whether anyone can participate)

(U4) A new forum is displayed.

(Flowchart of Determining Attention Degree of Rule Information 13)

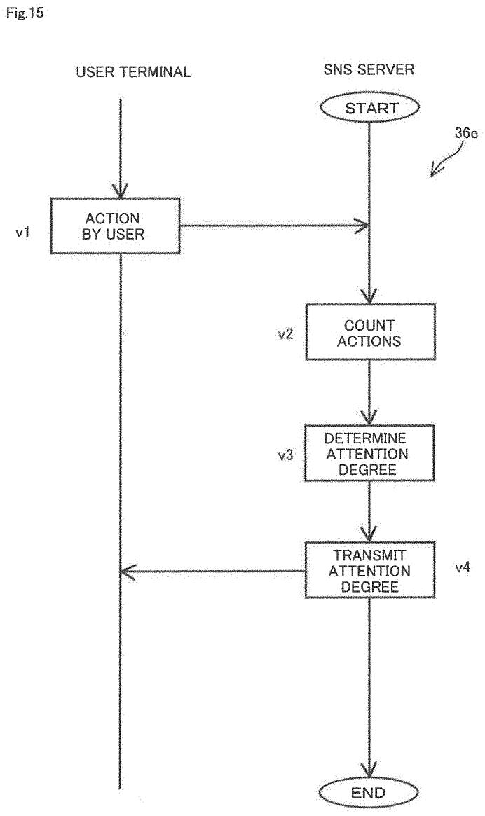

FIG. 15 is a flowchart illustrating one embodiment of processing of the SNS server program 36e used in the SNS server 14. FIG. 15 is mainly a flowchart of determining the attention degree.

(v1) Every time there is an action by the SNS user 15, the user terminal 16 transmits the action to the SNS server 14. The SNS server 14 receives the action.

For example, when a comment is entered in the comment screen portion 27a, the reaction screen portion 27d is clicked, the link 26c (see FIG. 10) for accessing the corresponding rule information 13 is clicked, or the collapse state is unfolded, information indicating that the above has happened is received by the SNS server 14.

(v2) The number of comments, the number of clicks of reactions, the number of clicks of the link, the number of times the collapsed state is unfolded are counted (added).

(v3) The attention degree is determined on the basis of any one of the number of comments, the number of clicks of reactions, the number of clicks of the link, and the number of times the collapsed state is unfolded. For example, in the present embodiment, a case where the total of the number of comments, the number of clicks of reactions, the number of clicks of the link, and the number of times the collapsed state is unfolded is up to ten is referred to as “little attention”, a case where the total is up to 100 is referred to as “intermediate attention”, and a case where the total is more than 1000 is referred to as “great attention”. The values of those threshold values may be changed. Each of the number of comments, the number of clicks of reactions, the number of clicks of the link, and the number of times the collapsed state is unfolded may be weighted, and the influence of any of the numbers may be caused to be greater. The attention degree may be determined with use of any one, two, or three of the number of comments, the number of clicks of reactions, the number of clicks of the link, and the number of times the collapsed state is unfolded. At this time, the threshold values and weightings described above may be applied for each of items to be added or to a plurality of items to be added.

(v4) The attention degree is transmitted to the user terminal 16. The attention degree is displayed on the display unit 16a of the user terminal.

(Flowchart of Determining Progress Degree of Rule Creation)

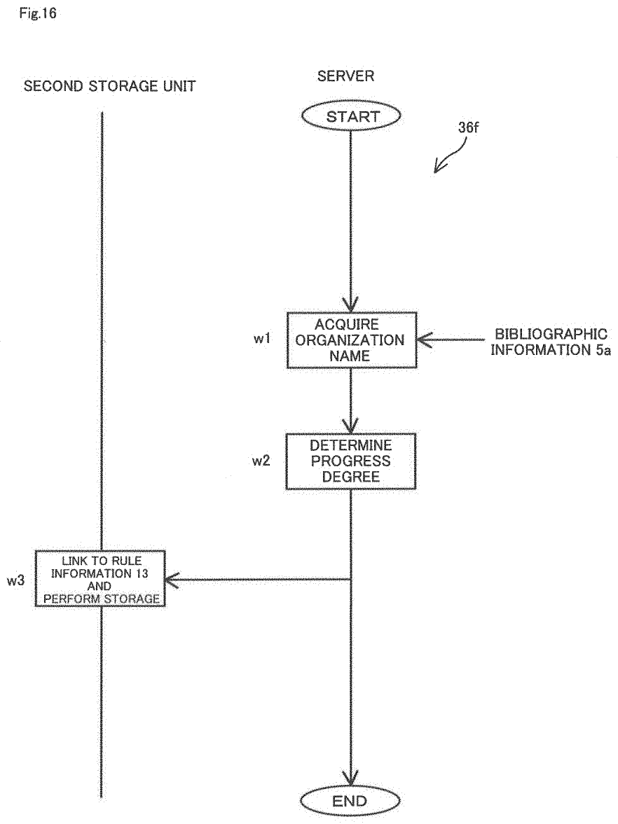

FIG. 16 is a flowchart illustrating one embodiment of processing of the server program 36f used in the server 1. FIG. 16 is mainly a flowchart of determining the progress degree of the rule creation.

(w1) The organization name 25d (see FIG. 10) that manages the rule information 13 is acquired from the concise information 5a.

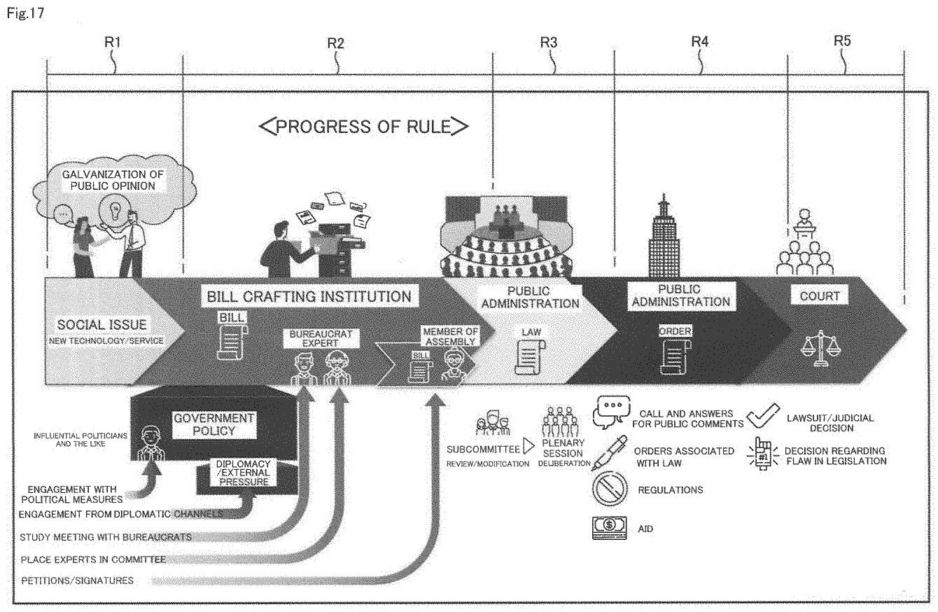

FIG. 17 is a schematic view illustrating one example of stages of the progress degree of the rule creation. The stages of the rule creation are divided into a first stage R1 of a social issue, a next stage R2 of a bill crafting institution, a next stage R3 of an assembly, a next stage R4 of a public administration, and a last stage R5 of a court. It is determined that the progress degree becomes higher as the stages proceed from R1 to R5.

(Stage R1 of Social Issue)

The stage R1 of a social issue is a stage in which public opinion is galvanized. In this stage, a social issue and corresponding new technologies and services are submitted from NGOs, companies, and the like. For example, NGOs, companies, and the like serve as organizations for determining the progress degree. The progress degree is a progress degree R1.

(Stage R2 of Bill Crafting Institution)

The stage R2 of the bill crafting institution is a stage in which a bill crafting institution is involved. In this stage, there is engagement with influential politicians and the like regarding political measures, there is diplomacy/external pressure from diplomatic channels, and a bill is created as a government policy. In this stage, a study meeting with bureaucrats and a committee by experts are established. In this stage, petitions, signatures, and the like are delivered to a member of the assembly, and a bill is created. As the bill crafting institution, a study meeting with the government and bureaucrats, a committee of experts, a member of the assembly that has created the bill, and the like serve as organizations for determining the progress degree, for example. The progress degree is a progress degree R2.

(Stage R3 of Assembly)

The stage R3 of an assembly is a stage in which a law is enacted by the assembly. For example, review/modification of a bill by a subcommittee and deliberation of the bill by a plenary session are performed. For example, a subcommittee, a plenary assembly, and the like serve as organizations for determining the progress degree. The progress degree is a progress degree R3.

(Stage R4 of Public Administration)

The stage R4 of the public administration is a stage in which an order is given from the public administration. For example, there are a call and answers for public comments, orders associated with the law, regulations, and aid, and the like. For example, a public administration and the like serve as organizations for determining the progress degree. The progress degree is a progress degree R4.

(Stage R5 of Court)

The stage R5 of the court is a stage in which a decision is made by a court. For example, a lawsuit/judicial decision, a decision regarding a flaw in the legislation, and the like are made. For example, a court and the like serve as organizations for determining the progress degree. The progress degree is a progress degree R5.

Returning to FIG. 16, (w2) the progress degrees R1 to R4 are determined by determining which organization name out of R1 to R4 (see FIG. 17) the acquired organization name 25d is equivalent to.

(w3) The acquired progress degree is stored into the second storage unit 8. At this time, the acquired progress degree is linked to the rule information 13. Then, the progress degree is posted on the SNS site 14a with the concise information 5a (not shown).

The acquired progress degree may be transmitted to the user terminal 16, and the progress degree may be displayed on the display unit 16a. At this time, the progress degree may be transmitted to the user terminal 16 via the SNS server 14.

### 5. Another Embodiment

### (Rule Watch System 44)

FIG. 18 illustrates another embodiment of the system 10 described above. In FIG. 18, a rule watch system (hereinafter referred to as a system) 44 according to another embodiment is illustrated. The system 44 illustrated in FIG. 18 is substantially the same as the system 10 described above, and hence the same parts are denoted by the same reference characters and description thereof is omitted. In the drawing, the illustration of the cleansing means 17, the tagging means 18, and the progress measuring means 29 is omitted.

For example, in the system 10 described above, the rule information 13 is processed, but technical information 56 and academic information 57 are further processed in the system 44. In other words, the processing by the collecting means 2 based on the collecting conditions 2a and the translating means 3 based on the translating conditions 3a performed for the rule information 13 is performed in processing of the technical information 56 and the academic information 57 by the system 44. In the present embodiment, the acquired technical information 56 and academic information 57 are transmitted to the analysis server 45 and are processed as described later.

The system 44 includes the crawler server 9 that collects the rule information 13, the technical information 56, and the academic information 57 on the Internet 12 on the basis of the collecting conditions 2a (see FIG. 5), the server 1 that acquires the rule information 13, the technical information 56, and the academic information 57 collected by the crawler server 9, and the analysis server 45 communicably connected to the server 1 over the Internet 12 (communication network) and the like. In the present embodiment, the third storage unit 46 is further included as an external data server.

(1) Outline

The system 44 collects the technical information 56 and the academic information 57 from the collecting sources 11 in addition to the rule information 13. The collected information is analyzed by the analysis server 45. As the result of analysis, the similarity degrees between the information and the importance degree of each information are acquired, for example. The result of the analysis is displayed on the display unit 16a of the user terminal 16. For example, when the similarity degrees are visualized, the relevance between the information can be grasped. Therefore, it become easier to predict the necessary technical field, the necessary technological investment, and the necessary academic knowledge on natural science and the like in rule creation. It becomes easier to grasp or predict the relevance of an organization or a person responsible for the necessary technologies and academic knowledge.

(Collecting Source 11)

Examples of the collecting source 11 of the technical information 56 (see FIG. 1) include a press release relating to technology of a company, information relating to an in-house technology posted on an HP of a company, and information on an HP of a technology-based fund and the like. In addition to the above, information on websites determined to be relating to practical realization of technology may be included.

Examples of the collecting source 11 of the academic information 57 (see FIG. 1) include information on a website on which published papers and literature of published patents, utility models, and the like in natural sciences and engineering such as mechanical engineering, civil engineering, and electronics are posted.

(Technical Information 56, Academic Information 57)

The technical information 56 and the academic information 57 include text data, image data, moving image (video) data, audio (sound recording data) data, files thereof, text files, image files, moving image (video) files, audio (sound recording data) files, and the like published on websites, SNSs, and the like serving as the collecting sources 11, for example. In addition to the above, mail magazines and transcription information from moving-image audio data may be included.

(2) Each Configuration

### (Feature-Word Acquisition Means 5a)

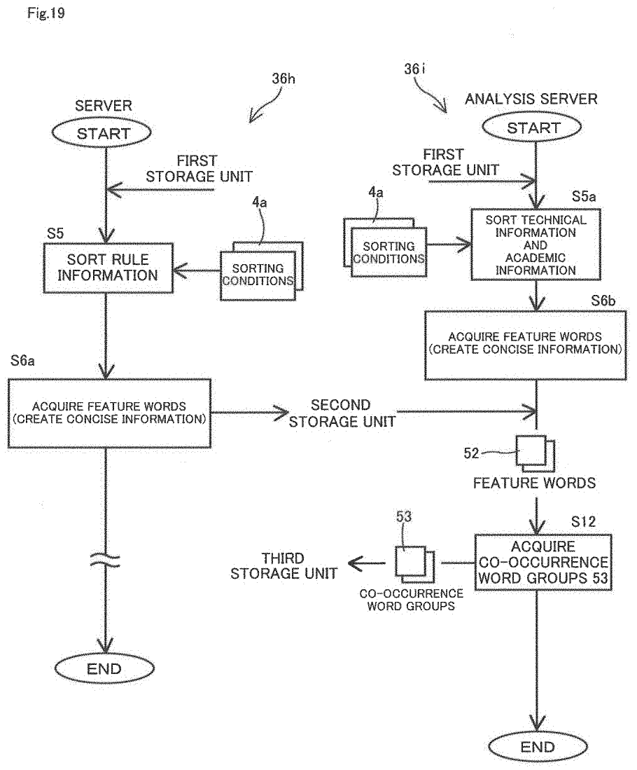

Each of the server 1 and the analyzing server 46 of the system 44 includes feature-word acquisition means 5a. The feature-word acquisition means 47 acquires feature words 52 (see FIG. 19) from each of the rule information 13, the technical information 56, and the academic information 57 that have been sorted. Each of those feature words 52 are linked to the rule information 13, the technical information 56, and the academic information 57 and are stored in the second storage unit 8. In the server 1, the simplifying means 5 may also serve as the feature-word acquisition means 5a.

(Input-Information Acquisition Means 16b, Operation-Input-Information Acquisition Means 16c)

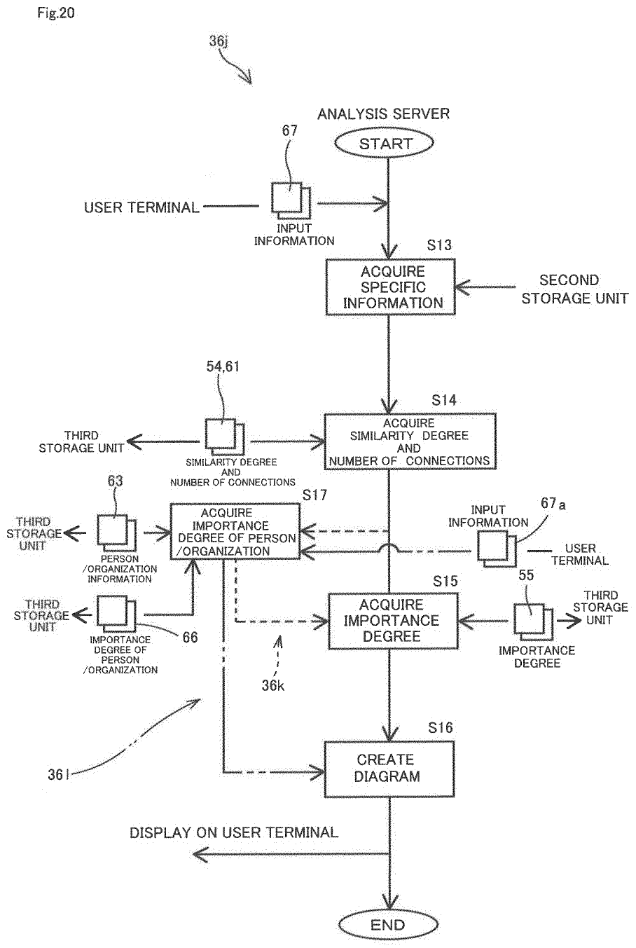

Input-information acquisition means 16b acquires input information 67 (see FIG. 20) linked to specific information (for example, rule information 13a in FIG. 20 described later) out of the rule information 13, the technical information 56, and the academic information 57 to be analyzed by input operation of the user 15. The acquired input information 67 is transmitted to the analysis server 45 by the user terminal 16.

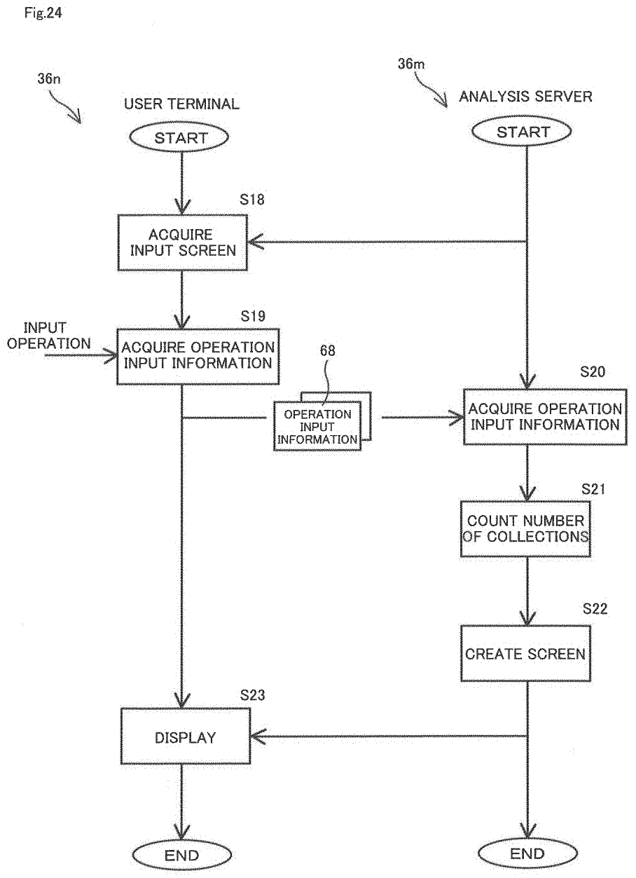

The operation-input-information acquisition means 16c acquires operation input information 68 (described later, see FIG. 24) input to the user terminal 16 by the input operation of the user 15. The user terminal 16 transmits the operation input information 68 to the analysis server 45.

(Analysis Server 45)

The analysis server 45 includes co-occurrence-word-group acquisition means 47 for acquiring a co-occurrence word group 53 (see FIG. 19) from the feature words 52 of each of the acquired rule information 13, technical information 56, and academic information 57, similarity-degree acquisition means 48 for acquiring a similarity degree 54 (see FIG. 20) in the rule information 13, the technical information 56, and the academic information 57 on the basis of the acquired co-occurrence word groups 53, importance-degree acquisition means 49 for acquiring an importance degree 55 (see FIG. 20) of the specific information 13a on the basis of the number by which connection is made to information with a similarity degree equal to or higher than a predetermined degree, screen creating means 51 for creating a display element to be displayed on the display unit 16a, and collection-screen creating means 71.

(Co-Occurrence-Word-Group Acquisition Means 47)

The co-occurrence-word-group acquisition means 47 acquires the co-occurrence word group 53 from the feature words 52 of each of the rule information 13, the technical information 56, and the academic information 57.

(Similarity Acquisition Means 48)

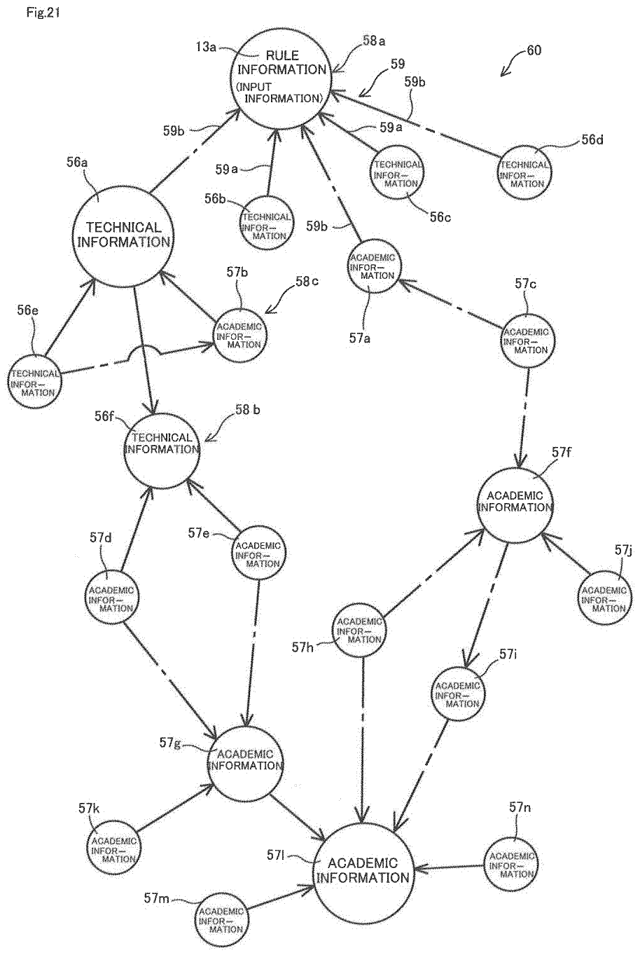

The similarity degree acquisition means 48 acquires the similarity degree 54 among the information in the rule information 13, the technical information 56, and the academic information 57 on the basis of the magnitude of the similarity between the co-occurrence word groups 53. The number (number of connections) of the information in a relationship of a predetermined similarity degree 54 is acquired. For example, the specific rule information 13a (see FIG. 21) has five information, in other words, specific technical information 56a, 56b, 56c, 56d and academic information 57a as information in a relationship of a predetermined similarity degree 54. In other words, the specific rule information 13a is in a relationship of the predetermined similarity degree 54 with five information, and the number of connections is five.

(Importance-Degree Acquisition Means 49, Person/Organization-Importance-Degree Acquisition Means 50)

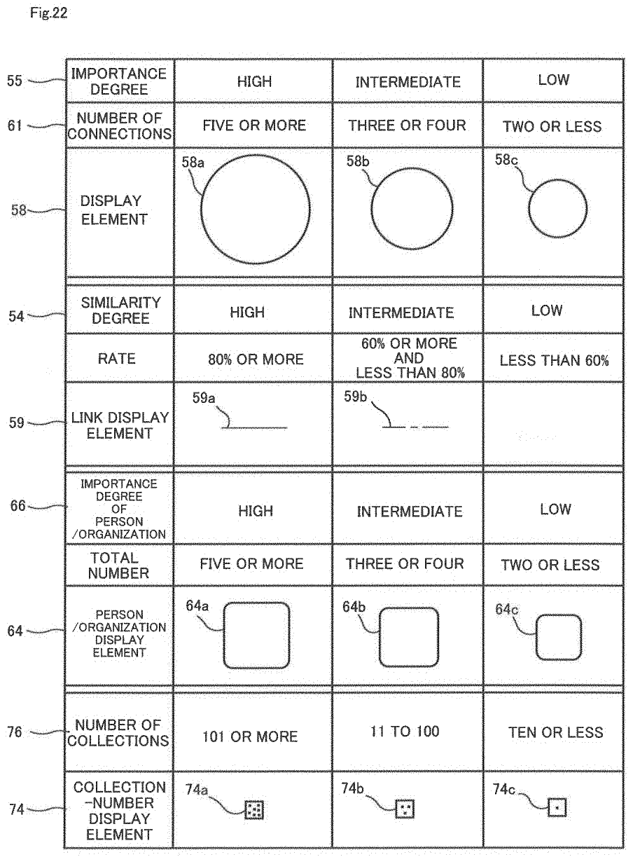

The importance-degree acquisition means 49 acquires the importance degree 55 of the corresponding information on the basis of a number of connections (see FIG. 22) 61. Person/organization-importance-degree acquisition means 50 acquires person/organization importance degrees 66 (see FIG. 22) of personal names or organization names on the basis of the number of the personal names or the organization names acquired as the co-occurrence word groups 53.

(Screen Creating Means 51, Collection-Screen Creating Means 75)

The screen creating means 51 creates a screen for displaying the magnitude of the similarity degree 54 and the importance degree 55 on the display unit 16a. The collection-screen creating means 75 creates a screen for displaying the magnitude of a number of collections 76 on the display unit 16a.

(4) Program

### (Flowchart of Acquiring Rule Information 13, Technical Information 56, and Academic Information 57)

Returning to FIG. 5, the flowchart illustrated in the drawing is a flowchart illustrating one embodiment of processing of the crawler program 36g used in the crawler server 9 of the system 44.

(S1a) The CPU 30 (see FIG. 3) of the crawler server 9 collects the technical information 56 and the academic information 57 in addition to the rule information 13 on the basis of the collecting conditions 2a from webpages published on the Internet 12.

In the present embodiment, text data and files are collected as the rule information 13, the technical information 56, and the academic information 57. Text information, titles, organization names, dates of publication are extracted from the text data, the files, and the like as the information 2b to be collected. As the information 2b to be collected, URLs of gathering sources are acquired in accordance with the collecting conditions 2a. The information to be acquired is substantially similar to that described in the system 10.

(S2a) The collected rule information 13, technical information 56, and academic information 57 are stored into the first storage unit 7. At this time, the information 2b to be collected is stored into the first storage unit 7 by being linked to each of the collected rule information 13, technical information 56, and academic information 57.

Conditions for saving the collected rule information 13, technical information 56, and academic information 57 in the first storage unit 7 are defined in the collecting conditions 2a. In the present embodiment, for example, it is checked whether information of which title, date of publication, and organization name entirely match with the title, the date of publication, and the organization name acquired from each of the acquired rule information 13, technical information 56, and academic information 57 is present in the first storage unit 7, and the storage is performed when there are no such information. As a result, a case where the same pieces of writing are collected is prevented.

(S3a) The rule information 13, the technical information 56, and the academic information 57 are acquired from the first storage unit 7 and are translated into a predetermined language on the basis of the translating conditions 3a. Processing after the translation is performed on the basis of the predetermined language. In the present embodiment, the predetermined language is English. The information 2b to be collected may be translated into the predetermined language.

Next, as with the system 10, the various data 21 of the date of publication is set to a predetermined format on the basis of the date table 22 provided for each language and is stored into the first storage unit 7 (see FIG. 6). The date table 22 is included in the collecting conditions 2a.

(S4a) The translated rule information 13, technical information 56, and academic information 57 are saved in the first storage unit 7.

(Processing of Acquiring Co-Occurrence Word Group 53)

FIG. 19 is a flowchart illustrating one embodiment of processing of the programs 36h, 36i used in the server 1 and the analysis server 45 of the system 44. In the flowchart of the system 44 illustrated in FIG. 19, substantially the same parts as those of the system 10 described above are denoted by the same reference characters and description thereof is omitted.

(S5) The rule information 13 is acquired from the first storage unit 7, and the rule information 13 relating to a predetermined category is sorted on the basis of the sorting conditions 4a. For example, technology themes such as drones, the blockchain, AI, batteries, and space technology are equivalent to a predetermined category.

(S5a) The technical information 56 and the academic information 57 are sorted by the analysis server 44. Processing of sorting is performed by an approach similar to that described in the system 10 (see FIG. 8).

(S6a) The concise information 5a is created from the rule information 13. In the present embodiment, the feature words 52 are extracted as the concise information 5a. The acquired feature words 52 are linked to the rule information 13 and are stored into the second storage unit 8 together with the rule information 13.

(S6b) The feature words 52 are extracted from each of the technical information 56 and the academic information 57. The acquired feature words 52 are linked to the corresponding technical information 56 and academic information 57 and are stored into the third storage unit 46 together with the technical information 56 and the academic information 57. As with the rule information 13, the concise information 5a may be created.

The acquired feature words 52, 52, 52 are words that characterize the content of each of the rule information 13, the technical information 56, or the academic information 57. A well-known approach can be used for the extraction of the feature words. For example, approaches of term frequency-inverse document frequency (TF-IDF), support vector machine (SVM), KeyGraph, or the like can be used.

In the present embodiment, the feature words 52 are extracted with use of the approach of TF-IDF. The approach by TF-IDF is an approach of extracting phrases on the hypothesis that phrases that frequently occur are important phrases, for example.

In addition to the above, the approach by SVM is an approach of extracting a phrase by assuming the nature in which feature words tend to be the subject of the topic and tend to appear in headlines.

The approach by KeyGraph is an approach based on the nature in which feature words tend to be the subject of the topic and tend to appear in headlines, an assumption that phrases of which occurrence frequency in a piece of writing is high serve as a foundation of the entire piece of writing in many cases, and an idea that the content supported by the foundation is the content desired to be conveyed the most, in other words, serves as the feature words. The feature words may be extracted with use of other approaches besides those approaches.

(S12) The feature words 52, 52, 52 corresponding to the rule information 13, the technical information 56, and the academic information 57 are acquired from the second and third storage units 8, 46 together with the rule information 13, the technical information 56, and the academic information 57. The analysis server 45 acquires the co-occurrence word groups 53, 53, 53 of the rule information 13, the technical information 56, and the academic information 5 corresponding to the acquired feature words 52, 52, 52.

The co-occurrence words are words of which relevance with a pivotal word is high and frequency of being used with the pivotal word is high. The co-occurrence words can be said to be words that frequently occur around the pivotal word and are present by one or more numbers. In the present embodiment, the feature word 52 is used as the pivotal word, and one group of words (co-occurrence words) used together with the feature word 52 in each of the information 13, 55, or 56 is the co-occurrence word group 53. A well-known approach can be used for the acquisition of the co-occurrence word group 53.

(Processing of Acquiring Co-Occurrence Word Group 53)

FIG. 20 is a flowchart illustrating one embodiment of processing of the program 36j used in the analysis server 45 of the system 44. The flowchart illustrated in FIG. 20 mainly acquires specific information that is similar to one specific information input from the rule information 13, the technical information 56, or the academic information 57 by the selection of the user 15 (see FIG. 18) and is a different type from that of the input information. The specific information is equivalent to the rule information 13a (see reference character 13a on the upper side of FIG. 21) specified by the user 15 out of the rule information 13 that is a bundle of a plurality of information relating to rule creation when the rule information 13 is taken as an example, for example. Index “a” indicates that the information is the specific rule information.

(S13) For example, the user 15 (see FIG. 18) selects the specific rule information from the rule information 13.

The user terminal 16 acquires information (input information 67) indicating the specific rule information 13a by the input operation of the user 15 and transmits the information to the analysis server 45. The analysis server 45 acquires the specific rule information 13a corresponding to the input information 67 from the second storage unit 8. The input information 67 is information for identifying the specified rule information 13a.

Indices are also applied to the technical information 56 and the academic information 57 when the specific information is indicated as with the rule information 13. When there is a plurality of information to be specified, indices are applied in alphabetical order in a manner of specific rule information 13a, 13b, 13c, for example.

(Correlation Diagram Indicating Similarity Degrees 54)

Detailed description is made from here with further reference to FIG. 21. FIG. 21 is a schematic view illustrating one embodiment of a screen displayed on the display unit 16a of the user terminal 16 (see FIG. 18). The screen illustrates a correlation diagram 60 of the similarity degrees. In the correlation diagram 60, a plurality of circular display elements 58 indicating the specific information of the rule information 13, the technical information 56, and the academic information 57 are illustrated. Straight-line forms that link the display elements 58, 58 to each other are link display elements 59. In the correlation diagram 60, the display elements 58 indicating information in a relationship in which the similarity degree 54 is an intermediate degree or higher are displayed, and those display elements 58, 58 are linked by the link display elements 59.

(S14) A co-occurrence word group 53a corresponding to the rule information 13a is acquired from the third storage unit 46 on the basis of the input information 67.

The co-occurrence word group 53a of the rule information 13a and the co-occurrence word groups 53, 53 of the technical information 56 and the academic information 57, respectively, are compared with each other. For example, the co-occurrence word group 53 of the technical information 56 is a bundle of the co-occurrence word groups 53a, 53b . . . of the technical information 56a, 56b, respectively.

As a result of the comparison described above, the technical information 56 and the academic information 57 similar to the co-occurrence word group 53a of the rule information 13a are acquired. In the present embodiment, information to which the co-occurrence word group 53a is similar is technical information 56a, 56b, 56c, 56d and academic information 57a as illustrated in FIG. 21. The similarity degrees 54 of the information 56a, 56b, 56c, 56d, 57a with respect to the rule information 13a are acquired.

(Similarity Degree 54)

In the present embodiment, for example, two co-occurrence word groups are compared with each other, and it is determined that the similarity degree is high when the two co-occurrence word groups are the same by 80% or more or when 80% or more of one co-occurrence word group is included in the other co-occurrence word group. It is determined that the similarity degree is an intermediate degree when the co-occurrence word groups are the same by 60% or more and less than 80% or when one is included in the other by 60% or more and less than 80%, it is determined that the similarity degree is a low degree when the co-occurrence word groups are the same by 20% or more and less than 60% or when one is included in the other by 20% or more and less than 60%, and it is determined that the similarity degree is “none” when the co-occurrence word groups are the same by less than 20% or one is included in the other by less than 20%.

(Number of Connections 61)

Next, the number of information (number of connections) in a relationship of being similar to the specific rule information 13a is acquired, for example. The acquired number of connections 61 is stored into the third storage unit 46. For example, in FIG. 21, five link display elements 59a, 59b extend from the display element 58 indicating the specific rule information 13a. In other words, it can be seen that there is five specific information of which similarity degree 54 with respect to the specific rule information 13a is equal to or higher than an intermediate degree. As the number of connections of information becomes greater, the information is presumed to be cited to other information, and hence the information is presumed to have high importance degree and value as information.

(S15, Importance Degree 55)

In the present embodiment, the importance degree 55 is high when the number of connections is five or more, the importance degree is an intermediate degree when the number of connections is three or four, and the importance degree is low when the number of connections is two or less. In the present embodiment, the number of connections 61 is divided into three stages, in other words, high, intermediate, and low, but the importance degree 55 may be “none” when the number of connections is 0. The division of the importance degree 55 may be in two stages or four stages or more.

The acquired similarity degree 54, the number of connections 61, and the importance degree 55 are stored into the third storage unit 46 together with the technical information 56a, 56b, 56c, 56d and the academic information 57a.

In the processing of acquiring the similarity degree 54 and the importance degree 55 described above, the similarity degree 54 and the importance degree 55 stored in the past may be read from the third storage unit 46. Whether the similarity degree 54 and the importance degree 55 have been stored in the past is determined on the basis of the date and time on which the similarity degree 54 and the importance degree 55 are stored, for example. For the similarity degree 54 and the importance degree 55 relating to the rule information 13, the technical information 56, and the academic information 57 collected at the date and time and thereafter, the similarity degree 54 and the importance degree 55 are acquired on the basis of the co-occurrence word groups 53 as described above.

(Processing of Acquiring Next Similarity Degree, Number of Connections, and Importance Degree)

Next, the co-occurrence word groups 53a . . . of the acquired specific technical information 56a, 56b, 56c, 56d and the specific academic information 57a and the co-occurrence word groups 53 of the technical information 56 and the academic information 57 other than those co-occurrence word groups are compared with each other, and the new similarity degree 54, new specific technical information 56e, 56f, and new specific academic information 57b, 57c are acquired. For the newly acquired specific technical information 56e, 56f and specific academic information 57b, 57c, each of the new number of connections 61 and the importance degree 55 is acquired. The newly acquired similarity degree 54, the number of connections 61, and the importance degree 55 are linked to corresponding new information and are stored into the third storage unit 46 together with the technical information 56e, 56f and the specific academic information 57b, 57c.

(Processing of Repeatedly Acquiring and Storing Similarity Degree, Number of Connections, Importance Degree, and Specific Information)

For the newly acquired specific technical information 56e, 56f and specific academic information 57b, 57c, the specific technical information, the academic information, the similarity degree 54, the number of connections 61, and the importance degree 55 are acquired and stored into the third storage unit 46 again. By repeating the processing and deepening the depth of search, a possibility of reaching the technical information 56 and/or the academic information 57 serving as the basis of the specific rule information 13a increases. In the present embodiment, the processing of acquiring the similarity degree 54, the specific technical information, the academic information, the number of connections 61, and the importance degree 55 is performed five times. The processing may be performed one to four times or may be performed six times or more.

(S16) The correlation diagram 60 is created on the basis of the acquired similarity degree 54, specific technical information, academic information, number of connections 61, and importance degree 55. FIG. 22 shows the display elements 58 and the link display elements 59 based on values of the importance degree 55 and the similarity degree 54. For example, in the present embodiment, the shape of the display element 58 becomes larger as the importance degree 55 increases. For example, display elements 58a, 58b correspond to the high importance degree 55 and the intermediate importance degree 55, respectively.

In the present embodiment, the magnitude of the similarity degree 54 is indicated by the length of the link display element 59. The similarity degree becomes higher as the link display element 59 becomes shorter. For example, the link display elements 59a, 59b correspond to the high similarity degree 54 and the intermediate similarity degree 54, respectively. In addition, in the present embodiment, the link display element of the intermediate similarity degree 54 is displayed in a long-dashed short-dashed line (see reference character 59b) in order to indicate whether the similarity degree 54 is an intermediate degree or a high degree in a clearer manner. For example, in FIG. 21, the technical information 56a, 56b, 56c, 56d and the academic information 57a are displayed as information similar to the rule information 13a. The similarity degree 54 of the technical information 56b, 56c linked by solid lines (see reference character 59a) out of the above with respect to the rule information 13a is a high degree. In the present embodiment, the link display elements 59 are displayed between information in relationships in which the similarity degrees 54 as the predetermined similarity degrees 54 are a high degree and an intermediate degree.

(Direction of Arrow of Link Display Element 59)

In the present embodiment, the link display elements 59 are directional lines. The directions of the arrows head toward the display elements 58 having a large number of co-occurrence word groups 53. For example, it may be assumed that the display element 58 to which the arrow heads toward is a master and the display element 58 on the opposite side is a servant. The arrows do not necessarily need to be illustrated.

(Correlation Diagram 60)

For example, from the correlation diagram 60, it can be grasped that the display element 58 indicating academic information 57l is one of starting points for the rule information 13a. It can be grasped that the rule information 13a is reached by routes on the left and right of the diagram from the academic information 57l serving as the starting point. The route on the right side is a route that heads upward from the academic information 57l serving as the starting point on the lower side of the diagram and reaches the rule information 13a through academic information 57i, 57f, 57c, 57a. Meanwhile, the route on the left side is a route that heads upward from the academic information 57l serving as the starting point on the lower side of the diagram and reaches the rule information 13a via academic information 57g, 57d, 57e and then through technical information 56f, 56a.

For example, in the correlation diagram 60, when the user 15 selects the display element 58 of which detail is desired to be displayed, the concise information 5a linked to the display element 58 may be displayed on the display unit 16a. The concise information 5a is displayed via the SNS server 4. Examples of a screen that displays the concise information 5a include the screens 23, 40, 41, 42 (see FIGS. 10, 11, 14) described above.

Text information indicating the concise information 5a may be acquired from the second storage unit 8 or the third storage unit 46 and may be displayed.

(Another Embodiment 62 of Correlation Diagram)

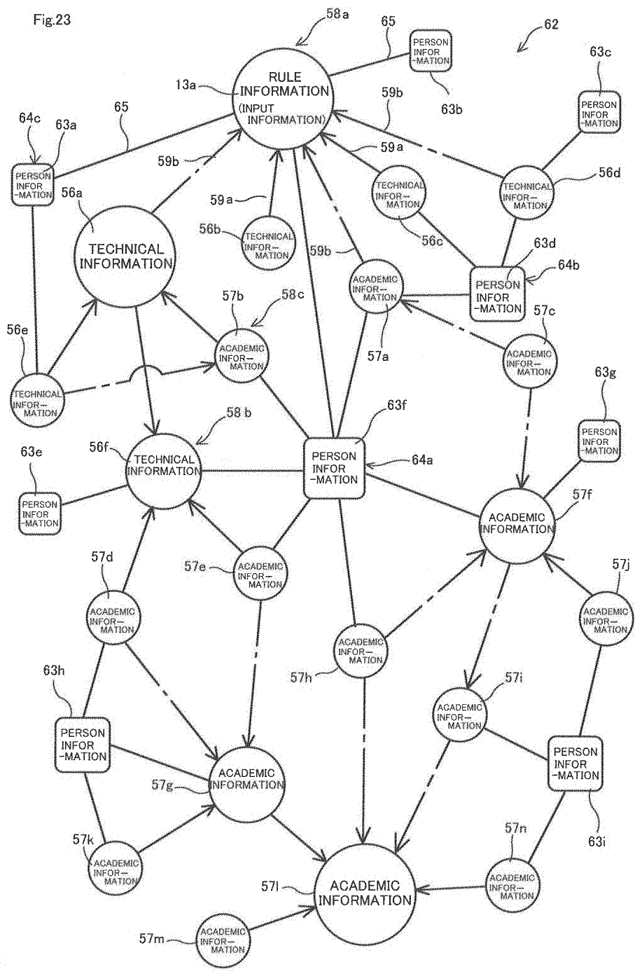

FIG. 23 illustrates another embodiment of the correlation diagram 60 described above. A person correlation diagram 62 illustrated in FIG. 23 is substantially the same as the correlation diagram 60 described above, and hence the same parts are denoted by the same reference characters and description thereof is omitted. The person correlation diagram 62 is different in that information relating to people/organizations is further indicated in the information in the correlation diagram 60 described above.

Returning to FIG. 20, a flowchart illustrating one embodiment of processing of the program 36k for displaying the person correlation diagram 62 is described. The processing of the program 36k (see dotted lines) is substantially the same as the processing of the program 36j described above, and hence different parts are described and the description of the same parts is omitted. The processing of the program 36k is different from the processing of the program 36j in that the processing of the program 36k includes a step (S17) of acquiring the importance degree of people/organizations between the step (S14) of acquiring the similarity degree and the number of connections and the step (S15) of acquiring the importance degree.

(S17, Person/Organization Information 63)

Information (person/organization information) 63 on personal names or organization names and the number of occurrences of the person/organization information 63 are acquired from the co-occurrence word group 53. The importance degree 66 of the person/organization is acquired on the basis of the number of occurrences. The importance degree 66 of the person/organization is stored in the third storage unit 46. Index “a” indicates that the information is specific person/organization information. When there is a plurality of information to be specified, indices are applied in alphabetical order in a manner of specific person/organization information 63a, 63b, 63c . . . , for example.

(Person/Organization Importance Degree 66)

In the information (13, 56, 57) in a relationship of the predetermined similarity degree 54 illustrated in the correlation diagram 60 described above, the number of occurrences of personal names or organization names is acquired from the co-occurrence word groups 53, 53, 53 of the information (13, 56, 57). The personal name/organization importance degree 50 of the personal name/organization information 63 is acquired on the basis of the number of occurrences. In the present embodiment, for example, the number of occurrences is high when the number of occurrences is ten times or more, the number of occurrences is intermediate when the number of occurrences is five times or more and less than ten times, and the number of occurrences is low when the number of occurrences is less than five times.

For example, in the present embodiment, the specific personal name/organization information 63a (see FIG. 23) occurs in the rule information 13a and the technical information 56e. The sum of the number of occurrences above is acquired as the personal name/organization importance degree 66. The number of occurrences is the total number of occurrences acquired from one or more specific information.

The person correlation diagram 62 is created on the basis of the acquired personal name/organization information 63 and personal name/organization importance degree 66. Description is made from here with further reference to FIG. 22. FIG. 22 shows person/organization display elements 64 created on the basis of values of the personal name/organization importance degree 66. In the present embodiment, the shape of the person/organization display element 64 becomes larger as the personal name/organization importance degree 66 increases. For example, personal name/organization display elements 64a, 64b, 64c correspond to the high personal name/organization importance degree 55, the intermediate personal name/organization importance degree 55, and the low personal name/organization importance degree 55, respectively.

A person link display element 65 links the person/organization display element 64 and the corresponding display element 58. For example, in the person correlation diagram 62 illustrated in FIG. 23, person/organization information 63f is linked to the rule information 13a, the technical information 56f, the academic information 57a, 57b, 57e, 57f, 57h.

In the present embodiment, as the predetermined personal name/organization importance degrees 66, the person/organization display elements 64 of the personal name/organization information 63 in relationships in which the importance degrees 66 are equal to or higher than a low degree are displayed. The personal name/organization importance degree 66 may be set to be equal to or higher than a high degree or equal to or higher than an intermediate degree.

(Person Correlation Diagram 62)

For example, from the person correlation diagram 62, it is presumed that the person/organization information 63f is an important person or organization for the rule information 13a because the person/organization information 63f is linked to seven information in the periphery thereof

(Others)

In FIG. 20, the processing of the step (S15) of acquiring the importance degree may be performed at the same time as or after the processing of the step (S17) of acquiring the importance degree of the person/organization.

The person/organization display elements 64 and the person link display elements 65 may be displayed to be added to the correlation diagram 60 (see FIG. 21) by the operation of the user terminal 16 by the user 15 after the correlation diagram 60 is displayed. For example, the importance degree of the person/organization is acquired by the acquisition of user information (see reference character 67a) from the user terminal 16 (S17), and the drawing is created (Step 16) and is displayed on the user terminal 16 (see processing of a long-dashed double-short-dashed line indicating one embodiment of processing of the program 36l).

(Grasping of Trend of Collected Information)

Next, with reference to FIG. 24, a method of grasping trends of the collected rule information 13, technical information 56, or academic information 57 is described. FIG. 24 is a flowchart illustrating one embodiment of processing of the programs 36m, 36n used in the analysis server 45.

(Preparation Step)

The CPU 30 (see FIG. 4) of the user terminal 16 makes a request for the download of an input screen to the analysis server 45. Conditions for grasping the trends are input via the input screen.

(Input Screen 69)

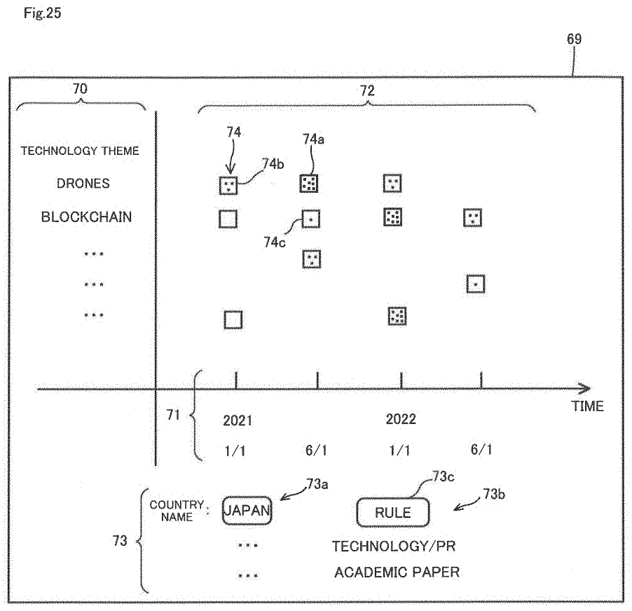

An input screen (trend screen) 69 is described with reference to FIG. 25 from here. In FIG. 25, a schematic view of the input screen displayed on the display unit 16a of the user terminal 16 is illustrated. The input screen 69 indicates the number of collections of the rule information 13, the technical information 56, or the academic information 57 in time series on the basis of the creation date and the like of each information for each technology theme. The input screen 69 is formed by a vertical-axis screen portion 70, a horizontal-axis screen portion 71, a collection-number screen portion 72 indicating the number of collections 76, and an operation screen portion 73 to be operated in order to change the conditions of collection.

(Vertical-Axis Screen Portion 70, Horizontal-Axis Screen Portion 71, Collection-number Screen 72, Operation Screen Portion 73)

In the vertical-axis screen portion 70, words (technology themes) relating to technologies out of the keywords 4c sorted on the basis of the sorting conditions 4a (see FIG. 8) are listed.

The horizontal-axis screen portion 71 is an axis indicating the date and time of creation. The date of creation (date and time of creation), the date of publication (date and time of publication), the date of update (date and time of update), and the like of information acquired by the collecting means 2 (see FIG. 18) are equivalent to the date of creation. In the present embodiment, the date of creation is employed. The date of publication may be employed when the date of creation cannot be acquired, and the date of update may be employed when the date of creation and the date of publication cannot be acquired. In the present embodiment, as the horizontal-axis screen portion 71, an axis on which scale marks are provided at a semiannual interval in a length of time of about two years is displayed.

The collection-number screen portion 72 is a screen portion in an inner region surrounded by the vertical-axis screen portion 70 and the horizontal-axis screen portion 71. In the collection-number screen portion 72, the number of acquired information (number of collections) are semiannually indicated by collection-number display elements 74 for each date and time of creation. In the present embodiment, for example, the number of acquisitions of the collection-number display element 74 is displayed by color shades (see FIG. 22). The number of collections increases as the color becomes darker. The collection-number display elements 74 are divided into three stages in accordance with the collected number. For example, the collection-number display elements 74 are formed by collection-number display elements 74a indicating that the number of collections is a large number of 101 items or more, collection-number display elements 74b indicating that the number of collections is an intermediate number of 11 items to 100 items, and collection-number display elements 74c indicating that the number of collections is a small number of one item to ten items.

The operation screen portion 73 is formed by a country/technology-selecting screen portion 73a for selecting the country name/technology theme for selecting the rule information 13, the technical information 56, or the academic information 57, and an information-selecting screen portion 73b. In the present embodiment, for example, the selecting screen portions 73a, 73b employ a form called a dropdown menu or a pulldown menu, and selectable options are listed on the screen in a selectable state when the user 15 touches the selecting screen portions 73a, 73b with a finger or a thumb. In the present embodiment, country names are listed in the country/technology-selecting screen portion 73b. The length of time or the interval of time indicated by the horizontal-axis screen portion 71 may be changeable in the operation screen portion 73. In the present embodiment, the country names displayed in the country/technology-selecting screen portion 73a and the information displayed in the information-selecting screen portion 73b are equivalent to the operation input information 68.

(S18) Returning to FIG. 24, the CPU of the user terminal 16 acquires the input screen 69 from the analysis server 45. In a state in which the operation input information 68 is not input, the collection-number display elements 73 are not displayed in the collection-number screen portion 72 of the input screen 69.

When the operation input information 68 as an initial value is preset, the collection-number display elements 73 may be displayed by the set operation input information 68 in the collection-number screen portion 72.

(S19) The user terminal 16 acquires the operation input information 68 by the operation of the user 15. The acquired operation input information 68 is transmitted to the analysis server 45. In the present embodiment, as information to be collected, Japan is selected from the country names in the country/technology-selecting screen portion 73a, and rule information is selected in the information-selecting screen portion 73b. A frame indicating that the option is selected is displayed in a screen portion around the selected option (see reference character 73c). In the present embodiment, display that surrounds texts of “RULE” and “JAPAN” by quadrilateral frame-like display elements is provided (see FIG. 25).

(S20) The analysis server 45 acquires the operation input information 68.

(S21) The number of collections is acquired on the basis of the operation input information 68.

(S22) The collection-number display elements 74 (see FIG. 22) are acquired on the basis of the acquired number of collections and are displayed in the collection-number screen portion 72, to thereby create the trend screen 69. The trend screen 69 is transmitted to the user terminal 16.

(S23) The trend screen 69 is displayed on the display unit 16a of the user terminal 16.

### Another Example

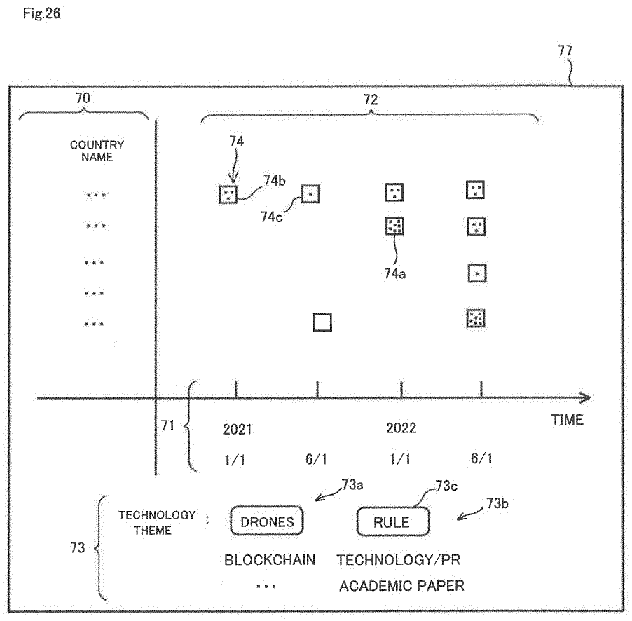

FIG. 26 illustrates another example of a trend screen 77. The trend screen 77 is substantially the same as the trend screen 69 described above, and hence description of the same parts is omitted. In the trend screen 77 illustrated in FIG. 26, a technology theme is selected in the country/technology-selecting screen portion 73a. Country names are listed in the vertical-axis screen portion 70. Rule information is selected in the information-selecting screen portion 73b. The technology theme displayed in the country/technology-selecting screen portion 73a and the information displayed in the information-selecting screen portion 73b are equivalent to the operation input information 68. In the present embodiment, the number of collections 76 of the rule information regarding the technology theme of drones is displayed in time series on a country-by-country basis.

### 6. Others

The first storage unit 7, the second storage unit 8, and the third storage unit 45 are external data servers in the embodiments described above, but one or more of the above may be provided in any of the server 1, the crawler server 9, the SNS server 14, and the analysis server 45.

The translating means 3 is provided in the crawler server 9 but may be provided in the server 1.

The crawler server 9, the SNS server 14, and the analysis server 45 are provided to be separate from the server 1, but all or any one or more of the functions of the crawler server 9, the SNS server 14, and the analysis server 45 may be integrally provided in the server 1. The crawler server 9 and the SNS server 14 may be one server. The crawler server 9 and the analysis server 45 may be one server. The SNS server 14 and the analysis server 45 may be one server.

The requesting means 20 may be provided in the server 1. In this case, the simplifying means 5 may have the function of the requesting means 20.

The attention-degree measuring means 28 is provided in the SNS server 14 and the progress-degree determining means 29 is provided in the server 1 in the present embodiments, but the attention-degree measuring means 28 and the progress-degree determining means 29 may be provided in other servers. The attention-degree measuring means 28 and the progress-degree determining means 29 may be provided in different servers outside the systems 10, 44.

The information on the new collecting source may be directly transmitted to the administrator terminal 10a in Step T3 in FIG. 12.

Users other than the users registered in the SNS may be able to place a request for adding a collecting source in Step T1 in FIG. 12.

Users other than the users registered in the SNS may be able to place a request for a form in Step U1 in FIG. 13.

The similarity degree 54 is divided into four stages, in other words, a high degree, an intermediate degree, a low degree, and “none” in the present embodiments but may be divided into two or three stages or five stages or more. The range of each stage can be freely set.

Regarding the predetermined similarity degree 54, information in a relationship of the similarity degree 54 equal to or higher than an intermediate degree is displayed in the correlation diagram 60 in the present embodiments, but information in a relationship of the similarity degree 54 equal to or higher than a high degree or equal to or higher than a low degree may be displayed, for example.

In the analysis server 46, all or a part of the processing of the cleansing means 17 and the processing of the tagging means 18 based on the classifying conditions 18a may be performed regarding the technical information 56 and the academic information 57.

The results of the similarity degrees 54 are stored into the third storage unit 46 in the present embodiments, but it is possible to store only the necessary similarity degrees 54. For example, the similarity degree 54 equal to or higher than a high degree, equal to or higher than an intermediate degree, or equal to or higher than a low degree may be recorded.

The number of connections 61 is stored in the present embodiments but may be stored as a degree such as a high degree, an intermediate degree, and a low degree. When there are no numbers of connections 61, “0” or “none” may be stored.

The shapes of the display elements 58 may be freely-selected shapes such as polygons, elliptical shapes, and pentagrams. The shapes of the display elements 58 may be changed to different shapes in accordance with the magnitude of the importance degree 54 instead of enlarging and shrinking the shapes. For example, the shapes may be circular shapes, quadrilateral shapes, and star-like shapes. The color of the display elements 58 may be changed. For example, the color may be changed to blue, yellow, and red or may be changed such that the color of red or blue becomes darker. The magnitude of the importance degree 54 may be indicated by color shades of a single color.

The types of lines may be the same as long as the magnitude of the similarity degree 54 can be visually recognized by the lengths of the link display elements 59.

The magnitude of the similarity degree 54 may be indicated by the thickness of the link display element 59. For example, the similarity degree 54 is set to be higher as the line becomes thicker. When the magnitude of the similarity degree 54 is indicated by the types of line of the link display elements 59, it may be indicated that the similarity degree 54 is higher as the line approaches a solid line in the order of a solid line, a long-dashed short-dashed line, a long-dashed double-short-dashed line, and a dotted line, for example.

The arrows of the link display elements 59 may head toward the display element 58 of which number of the co-occurrence word groups 53 is small. When the numbers of the co-occurrence word groups 53 are the same, the arrows may head toward both of the display elements 58, 58 or no arrows may be applied.

The acquisition of the similarity degrees 54 of the technical information 56 and the academic information 57 are repeated starting from the specific rule information 13a in the embodiment described above, but the acquisition of the similarity degrees 54 of the rule information 13 and the academic information 57 or the rule information 13 and the technical information 56 may be repeated starting from the specific technical information 56a or the specific academic information 57a.

Features described as other features can be used by being combined, as appropriate, with the embodiment described above.

### 7. Conclusion

The system 10 includes: the crawler server 9 including: the collecting means 2 for collecting the rule information 13 including information relating to rule creation of an environmental issue, a human rights issue, a legal regulation, standardization, or the like published via the Internet 12 on the basis of the collecting condition 2a including the collecting source 11 registered in advance; and the translating means 3 for translating, when the collected rule information 13 is different from a language to which translation is to be made, the collected rule information 13 to a predetermined language to which translation is to be made on the basis of the translating condition 3a; the server 1 including: the sorting means 4 for sorting rule information relating to a predetermined category from the translated rule information 13 on the basis of the sorting condition 4a; the simplifying means 5 for forming the concise information 5a on the basis of predetermined information acquired from the sorted rule information 13; and the progress-degree measuring means 29 for measuring the progress degree of the rule creation on the basis of organization information including an organization serving as the collecting source 11 of the rule information 13; and the SNS server 14 that manages the SNS site 14a for posting the concise information 5a as a first post and includes: the posting means 6 for making the first post; and the attention-degree measuring means 28 for measuring the attention degree of the corresponding rule information 13 on the basis of at least one of the number of comments, the number of reactions, the number of clicks of links for accessing the corresponding rule information, and the number by which collapsed display is unfolded by the user 15 corresponding to the concise information 5a that is posted. The rule watch method is realized by the system 10.

The SNS has a function of submitting, sharing, and spreading information. When the information 13 relating to rule creation is simplified and widely spread on the SNS, comments, reactions, and the like by a large number of SNS users across fields can be gathered.

Therefore, it becomes possible to encourage discussions to deal with social issues by crossing fields in a cross-cutting manner by the users 15 in various positions belonging to the SNS. In addition, by observing the reactions of those SNS users 15, it becomes possible to notice important rule creation signs such as whether the rule creation is rule creation to be welcomed or is rule creation that requires vigilance, and global rule creation can be monitored by the SNS users.

The system 10, the rule watch method, the server 1, and the server programs 36, 36h, 36i as above include the step of sorting the collected rule information into a predetermined category on the basis of the sorting condition and the step of forming the concise information from the sorted rule information, and hence the rule information 13 can be separated by category and put together as the concise information 5a. Therefore, the user 15 can easily come into contact with the content of the rule information 13. The reactions of the users 15 can be easily gathered on the SNS site 14a.

The system 10 and the rule watch method includes, before the step of sorting, the step of translating, when the collected rule information includes a language different from a predetermined language, the language into the predetermined language on the basis of the translating condition 4a so as to unify the language of the step of sorting and steps after the step of sorting, and hence the rule information 13 at home and abroad can be put together as the concise information 5a.

The system 10, the rule watch method, the SNS server 14, and the SNS server program 36e include the attention degree measuring means 28 for measuring the attention degree of the corresponding rule information 13 on the basis of at least one of the number of comments, the number of reactions, the number of clicks of links for accessing the corresponding rule information by the user 15 corresponding to the posted concise information, and a button for unfolding the collapsed display, and hence the attention degree of the user 15 on the rule information 13 can be understood. The rule information 13 of which attention degree is high may be one sign that is not to be missed regarding important rule creation including whether the interest, vigilance, and the like of the users 15 are good or bad.

The system 10, the rule watch method, the server 1, and the server program 36f include the progress-degree measuring means 29 for measuring the progress degree of the rule creation on the basis of the organization 25d that is the collecting source 11 of the rule information 13. Therefore, the degree by which the rule creation is reached can be known, and hence determination on whether the information is information that requires immediate action or information to be noted can be aided.

The SNS server 14 includes the requesting means 20 for requesting the addition of a desired collecting source of the rule information 13 so as to allow the SNS users 15 to place a request, and hence the information posted on the SNS site 14a is created by the users 15. Therefore, the tendency of posts relating to the rule information 13 that the users 15 are interested in being made on the SNS site increases.

The SNS server 14 includes the forum creating means 19 for creating a forum on which the specific SNS users 15 are able to comment regarding the predetermined rule information 13 so as to allow the SNS users 15 to perform the creation, and hence it becomes possible to encourage the users 15 of the SNS to talk with each other. Therefore, the reactions of the users can be gathered in an even easier manner.

The rule watch method indicated in the system 44 includes: the step of collecting the technical information 56 relating to practical realization of technology such as technological investment or a press release relating to science and technology and the academic technical information 57 relating to the progress of technology such as a paper or a patent literature relating to science and technology from the Internet on the basis of the collecting condition 2a registered in advance including the collecting source of the technical information and the academic information; and the step of acquiring the co-occurrence word group 53 from each of the rule information and the collected technical information and academic technical information and acquiring the similarity degree 54 among information in the rule information, the technical information, and the academic information on the basis of the similarity degree of the each co-occurrence word group.

Therefore, the connection in the rule information, the technical information, and the academic information can be easily grasped.

The rule watch method as above includes the step of displaying the magnitude of the similarity degree on the display unit of the user terminal in accordance with the thickness or the length of a line that connects similar display elements out of the display elements 58 indicating the rule information 13, the technical information 56, and the academic information 57, and hence it becomes easier to grasp the connection among the rule information, the technical information, and the academic information.

The rule watch method as above includes: the step of sorting the collected rule information 13, the technical information 56, and the academic information 57 into predetermined categories on the basis of the sorting condition 4a; and the step of displaying the display element 58 indicating the rule information, the technical information, or the academic information on a graph including an axis indicating a corresponding country or the category and a time axis, and hence the trend of the rule information, the technical information, or the academic information is easily grasped for each country or category.

The user terminal 16 is communicably connected to the server 1. The server 1 collects the rule information 13 relating to rule creation of an environmental issue, a human rights issue, a legal regulation, standardization, or the like, the technical information 56 relating to practical realization of technology such as technological investment or a press release relating to science and technology, and the academic information 57 relating to the progress of technology such as a paper or a patent literature relating to science and technology from the Internet on the basis of the collecting condition 2a registered in advance, and sorts the rule information, the technical information, and the academic information by the predetermined sorting condition 4a. The user terminal 16 includes: the operation-input-information acquisition means 16c for acquiring the operation input information 68 including a country name or a technology theme name by operation of the user; and the display unit 16a that displays a screen that is created by the server and indicates the number of the rule information, the technical information, or the academic information corresponding to the operation input information in time series.

Therefore, the trend of the rule information, the technical information, or the academic information is easily grasped for each country or category by simple operation.

### REFERENCE SIGNS LIST

1 Server, 2 Collecting means, 3 Translating means, 4 Sorting means, 5 Simplifying means, 5a Concise information, 6 Posting means, 7 First storage unit, 8 Second storage unit, 9 Crawler server, 10 Rule watch system (system), 11 Collecting source, 12 Internet, 13 Rule information, 14 SNS server, 15 User, 16 User terminal, 17 Cleansing means, 18 Tagging means, 19 Forum creating means, 20 Requesting means, 21 Data of date of publication, 22 Date table, 23 Posting screen, 24 Common screen portion, 25 Extracted-keyword screen portion, 26 Summary screen portion, 27a Comment screen portion, 27b Concern screen portion, 27c Share screen portion, 27d Reaction screen portion, 28 Attention-degree measuring means, 29 Progress-degree determining means, 30 CPU, 31 Memory, 32 Recording device, 33 Connection port, 34 Communication circuit, 35 Bus line, 36a to 36n Server program, 37 Browser program, 38 OS, 39 Addition screen portion, 40 Home screen, 41 Right screen, 42 Left screen, 44 Rule watch system, 45 Analysis server, 46 Third storage unit, 47 Co-occurrence-word-group acquisition means, 48 Similarity-degree acquisition means, 49 Importance-degree acquisition means, 50 Person/organization-importance-degree acquisition means, 51 Screen creating means, 52 Feature word, 53 Co-occurrence word group, 54 Similarity degree, 55 Importance degree, 56 Technical information, 57 Academic information, 58 Display element, 59 Link display element, 60 Correlation diagram, 61 Number of connections, 62 Person correlation diagram, 63 Person/organization information, 64 Person/organization display element, 65 Person link display element, 66 Importance degree of person/organization, 67 Input information, 68 Operation input information, 69 Input screen (trend screen), 70 Vertical-axis screen portion, 71 Horizontal-axis screen portion, 72 Collection-number screen portion, 73 Operation screen portion, 74 Collection-number display element, 75 Acquisition-screen creating means, 76 Number of collections, 77 Input screen (trend screen).

1. A rule watch method executed by one or a plurality of computers, the rule watch method comprising:
a step of collecting rule information including information relating to rule creation of an environmental issue, a human rights issue, a legal regulation, standardization, or the like published via the Internet on a basis of a collecting condition including a collecting source registered in advance;
a step of forming concise information on a basis of predetermined information acquired from the rule information; and
a step of creating a thread as a first post on an SNS site for posting the concise information.

2. The rule watch method according to claim 1, further comprising, between the step of collecting the rule information and the step of forming the concise information:
a step of translating, when the collected rule information includes a language different from a predetermined language to which translation is to be made, the language to the predetermined language on a basis of a translating condition;
a step of sorting the collected rule information that is translated into a predetermined storage unit; and
a step of forming the concise information from the sorted rule information.

3. (canceled)

4. The rule watch method according to claim 1, further comprising a step of measuring an attention degree of corresponding rule information on a basis of at least one of a number of comments, a number of reactions, a number of clicks of links for accessing the corresponding rule information, and a number by which collapsed display is unfolded by the user corresponding to the concise information that is posted; and
a step of displaying the attention degree on a terminal of the user.

5. The rule watch method according to claim 1, further comprising a step of determining a progress degree of the rule creation on a basis of organization information including an organization serving as the collecting source of the rule information, wherein the progress degree is posted on the SNS site together with the concise information.

6. A rule watch system, comprising:
a crawler server configured to:
collect rule information including information relating to rule creation of an environmental issue, a human rights issue, a legal regulation, standardization, or the like published via the Internet on a basis of a collecting condition including a collecting source registered in advance; and
translate, when the collected rule information is different from a language to which translation is to be made, the collected rule information to a predetermined language to which translation is to be made on a basis of a translating condition;
a server configured to:
sort rule information relating to a predetermined category from the translated rule information on a basis of a sorting condition;
form concise information on a basis of predetermined information acquired from the sorted rule information; and
measure a progress degree of the rule creation on a basis of organization information including an organization serving as the collecting source of the rule information; and
an SNS server that manages an SNS site for posting the concise information as a first post and configured to:
create a thread as a first post; and
measure an attention degree of corresponding rule information on a basis of at least one of a number of comments, a number of reactions, a number of clicks of links for accessing the corresponding rule information, and a number by which collapsed display is unfolded by the user corresponding to the concise information that is posted.

7. A server, which forms information to be posted and in which an SNS site for posting a first post is prepared, the server configured to:
sort rule information, which is collected on a basis of a collecting condition including a collecting source registered in advance and which includes information relating to rule creation of an environmental issue, a human rights issue, a legal regulation, standardization, or the like published via the Internet, into rule information relating to a predetermined category on a basis of a sorting condition; and
form concise information on a basis of predetermined information acquired from the sorted rule information.

8. The server according to claim 7, further configured to determine a progress degree of the rule creation on a basis of organization information including an organization serving as the collecting source of the rule information.

9-12. (canceled)

13. A non-transitory computer readable medium including a server program, which forms the information to be posted and in which an SNS site for posting a first post is prepared, the server program causing a computer to:
sort rule information, which is collected on a basis of a collecting condition including a collecting source registered in advance and which includes information relating to rule creation of an environmental issue, a human rights issue, a legal regulation, standardization, or the like published via the Internet, into rule information relating to a predetermined category on a basis of a sorting condition; and
form concise information from the sorted rule information.

14. The non-transitory computer readable medium according to claim 13, further causing: a progress degree of the rule creation to be determined on a basis of organization information including an organization serving as the collecting source of the rule information.

15-16. (canceled)

17. The rule watch method according to claim 1, further comprising:
a step of collecting technical information relating to practical realization of technology such as technological investment
or a press release relating to science and technology
and academic information relating to a progress of technology such as a paper or a patent literature relating to science and technology from the Internet on a basis of a collecting condition registered in advance including a collecting source of the technical information and the academic information;
a step of acquiring a co-occurrence word group from each of the rule information and the collected technical information and academic technical information; and
a step of acquiring a similarity degree among information in the rule information, the technical information, and the academic information on a basis of a similarity degree of the each co-occurrence word group.

18. The rule watch method according to claim 17, further comprising a step of displaying a magnitude of the similarity degree on a display unit of a user terminal in accordance with a thickness or a length of a line that connects similar display elements out of display elements indicating the rule information, the technical information, and the academic information.

19. The rule watch method according to claim 17, further comprising:
a step of sorting the collected rule information, technical information, and academic information into predetermined categories on a basis of a sorting condition; and
a step of displaying a display element indicating the rule information, the technical information, or the academic information on a graph including an axis indicating a corresponding country or the category and a time axis.

20-21. (canceled)

22. The rule watch method according to claim 18, further comprising:
a step of acquiring person/organization information and an importance degree of the person/organization information from the co-occurrence word group; and
a step of displaying a display element indicating the person/organization information and a display element indicating the corresponding rule information, technical information, and academic information on the display unit by connecting the display element indicating the person/organization information and the display element indicating the corresponding rule information, technical information, and academic information to each other by a link display element.

23. The rule watch method according to claim 18, further comprising:
a step of selecting specific rule information out of the rule information; and
a step of displaying a display element indicating the technical information or the academic information similar to the specific rule information and a display element indicating the technical information or the academic information similar to that technical information or academic information similar to the specific rule information on the display unit.
